(19) United States
(12) Patent Application Publication
(10) Pub. No.: US 2010/0153520 A1
(43) Pub. Date: Jun. 17, 2010

(54) METHODS, SYSTEMS, AND MEDIA FOR CREATING, PRODUCING, AND DISTRIBUTING VIDEO TEMPLATES AND VIDEO CLIPS

(76) Inventors: Michael Daun, Brussels (BE); Jonathan Kenny, Amsterdam (NL)

Correspondence Address: Byrne Poh LLP, 11 Broadway, Ste 865, New York, NY, 10004, US

(21) Appl. No.: 12/336,011

(22) Filed: Dec. 16, 2008

(51) Int. Cl. G06F 3/048; G06F 15/16

(52) U.S. Cl. 709/218; 715/723

(57) ABSTRACT

Methods, systems, and media for creating, producing, and distributing video templates and video clips are provided.

### TECHNICAL FIELD

The disclosed subject matter relates to methods, systems, and media for creating, producing, and distributing video templates and video clips.

### BACKGROUND

With the number of people having broadband Internet access continually growing, the consumption of a broad range of online media is becoming increasingly widespread. For example, it is estimated that over forty percent of users listen to, watch, or seek to download some form of online media and that over fifty percent of these users have purchased some form of online media. In particular, Internet video streaming and sharing websites, such as YouTube, Hulu, and Qik, are becoming increasingly popular. These websites allow users to consume television shows, personal productions, music videos, and other types of media. In addition to Internet video streaming and sharing websites, there are a number of social networking websites (e.g., Facebook, MySpace, Vimeo, and Bebo), Internet television websites (e.g., blip.tv and Veoh), and other media websites (e.g., Flickr) that provide users with similar media viewing and sharing features.

With these websites, users may create and distribute online videos as an inexpensive means of distributing content to other users anywhere in the world. For example, it provides broadcasters with the ability to offer catch-up services that reinforce traditional broadcast schedules and the potential to offer targeted advertising. For amateur video producers, online video offers a platform for posting homemade videos to a global audience.

However, the creation of online video content requires a number of processes—e.g., pre-production, production, post-production, and distribution. For example, the pre-production process includes script writing and storyboard construction, while the post-production process includes timing and mixing and the distribution process includes advertising and packaging. Most users and, in particular, amateur video producers, lack the creative and technological expertise to create professional-looking videos. In addition, these users typically do not have the proper tools.

Thus, it is desirable to provide mechanisms that allow users to create and distribute video templates, where these video templates may be used by end users to create, produce, and distribute customized video clips.

Accordingly, it is desirable to provide methods, systems, and media that overcome these and other deficiencies of the prior art.

### SUMMARY

Methods, systems, and media for creating, producing, and distributing video templates and video clips are provided.

In accordance with some embodiments, a method for assisting end users create customized video clips is provided, the method comprising: displaying a timeline interface in a window area that includes a plurality of layers, wherein the timeline interface allows a user at a first device to create a video template; displaying an asset interface in the window area that allows the user at the first device to select from a plurality of media assets for insertion into the video template; receiving, for each of the plurality of layers, selections from the user at the first device to insert and arrange at least one of the plurality of media assets from the asset interface into a plurality of media blocks in the timeline interface for a video template; receiving at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block; receiving, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of a video length, a playback speed, a video setting, a volume setting, a screen position, a mask setting, and a video effect; and storing the video template and information associated with the user at the first device in a database that includes a plurality of video templates for distribution to the end users.

In some embodiments, a system for assisting end users create customized video clips is provided, the system comprising: displaying a timeline interface in a window area that includes a plurality of layers, wherein the timeline interface allows a user at a first device to create a video template; means for displaying an asset interface in the window area that allows the user at the first device to select from a plurality of media assets for insertion into the video template; means for receiving, for each of the plurality of layers, selections from the user at the first device to insert and arrange at least one of the plurality of media assets from the asset interface into a plurality of media blocks in the timeline interface for a video template; means for receiving at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block; means for receiving, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of: a video length, a playback speed, a video setting, a volume setting, a screen position, a mask setting, and a video effect; and means for storing the video template and information associated with the user at the first device in a database that includes a plurality of video templates for distribution to the end users.

In some embodiments, a system for assisting end users create customized video clips is provided, the system comprising: a processor that: displays an asset interface in the window area that allows the user at the first device to select from a plurality of media assets for insertion into the video template; receives, for each of the plurality of layers, selections from the user at the first device to insert and arrange at least one of the plurality of media assets from the asset interface into a plurality of media blocks in the timeline interface for a video template; receives at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block; receives, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of: a video length, a playback speed, a video setting, a volume setting, a screen position, a mask setting, and a video effect; and stores the video template and information associated with the user at the first device in a database that includes a plurality of video templates for distribution to the end users.

In some embodiments, a computer-readable medium storing computer-executable instructions that, when executed by a processor, causes the processor to perform a method for assisting end users create customized video clips is provided. The method comprises: displaying a timeline interface in a window area that includes a plurality of layers, wherein the timeline interface allows a user at a first device to create a video template; displaying an asset interface in the window area that allows the user at the first device to select from a plurality of media assets for insertion into the video template; receiving, for each of the plurality of layers, selections from the user at the first device to insert and arrange at least one of the plurality of media assets from the asset interface into a plurality of media blocks in the timeline interface for a video template; receiving at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block; receiving, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of: a video length, a playback speed, a video setting, a volume setting, a screen position, a mask setting, and a video effect; and storing the video template and information associated with the user at the first device in a database that includes a plurality of video templates for distribution to the end users.

### BRIEF DESCRIPTION OF THE DRAWINGS

FIG. 1 is a diagram of a mechanism for creating and distributing video templates in accordance with some embodiments of the present invention.

FIG. 2 is a diagram showing an illustrative example of a video template project interface used for creating and/or editing video templates in accordance with some embodiments of the present invention.

FIG. 3 is a diagram showing an illustrative example of a video template project interface including various media windows in accordance with some embodiments of the present invention.

FIG. 4 is a diagram showing an illustrative example of a video template project interface including various parameter windows in response to selecting an inserted media asset in accordance with some embodiments of the present invention.

FIG. 5 is a diagram showing an illustrative example of a video template project interface including a volume interface in accordance with some embodiments of the present invention.

FIG. 6 is a diagram showing an illustrative example of a video template project interface including various end user media block windows in accordance with some embodiments of the present invention.

FIG. 7 is a diagram of a mechanism for creating a video clip using a video template in accordance with some embodiments of the present invention.

FIGS. 8 and 9 are diagrams showing illustrative examples of video template selection interfaces or video template catalogue displayed to an end user in accordance with some embodiments of the present invention.

FIG. 10 is a diagram showing an illustrative example of a video template preview interface displayed to an end user in accordance with some embodiments of the present invention.

FIGS. 11 and 12 are diagrams showing illustrative examples of a video template interface and an interface for describing the video template and the end user-generated media content for insertion into the video template in accordance with some embodiments of the present invention.

FIGS. 13 and 14 are diagrams showing illustrative examples of instructions that are provided to an end user, where the instructions provide direction on how to generate video content suitable for the selected video template in accordance with some embodiments of the present invention.

FIG. 15 is a diagram showing an illustrative example of an interface including an indicator that indicates that the displayed content should be replaced with end user-generated media content in accordance with some embodiments of the present invention.

FIGS. 16-18 are diagrams showing illustrative examples of an interface for uploading, recording (e.g., from a networked camera, such as a webcam), and/or editing end user-generated media content in accordance with some embodiments of the present invention.

FIG. 19 is a diagram showing an illustrative example of an interface for uploading, recording (e.g., from a networked camera, such as a webcam), and/or editing end user-generated media content that includes an indicator, where the indicator indicates that the displayed content should be replaced with end user-generated media content in accordance with some embodiments of the present invention.

FIG. 20 is a diagram showing an illustrative example of an interface for uploading end user-generated media content in response to removing the end user-generated media content (e.g. using a networked camera, such as a webcam) in accordance with some embodiments of the present invention.

FIG. 21 is a diagram showing an illustrative example of an interface for uploading end user-generated media content using a webcam or any other suitable video capturing device in accordance with some embodiments of the present invention.

FIG. 22 is a diagram showing an illustrative example of an interface for inserting end user-generated textual content in accordance with some embodiments of the present invention.

FIG. 23 is a diagram showing an illustrative example of an interface for selecting audio stored in a database or any other suitable storage device and/or for inserting end user-generated audio content in accordance with some embodiments of the present invention.

FIG. 24 is a diagram showing an illustrative example of every instruction provided to an end user for creating a video clip with the selected video template in accordance with some embodiments of the present invention.

FIGS. 25-28 are diagrams showing illustrative examples of a purchasing interface for the video clip in accordance with some embodiments of the present invention.

FIG. 29 is a schematic diagram of an illustrative system suitable for implementation of an application that creates, produces, and distributes video templates and video clips in accordance with some embodiments of the present invention.

FIG. 30 is a diagram showing an illustrative example of the multiple servers and/or databases that may be used in accordance with some embodiments of the present invention.

FIG. 31 is a detailed example of the server and one of the workstations of FIG. 29 that may be used in accordance with some embodiments of the present invention.

### DETAILED DESCRIPTION

In accordance with various embodiments, methods, systems, and media provide mechanisms through which video templates and video clips may be created, produced, and distributed.

In accordance with the some embodiments, a media application (sometimes referred to herein as “the application”) for creating, producing, and distributing video templates and video clips is provided. The application may be used by a user (e.g., a video artist, a producer, or any other suitable user) to create one or more video templates.

Generally speaking, a video template is an interactive video template designed by a user with particular parameters and instructions to assist end users (e.g., clip buyers) create video clips by inserting end user-generated media content. These video templates may include storyboards that are, for example, funny, entertaining, romantic, enlightening, thought-provoking, interesting, emotional, etc. After creating one or more video templates, these video templates may be aggregated and stored in a video template database and/or published in a video template catalogue, where each video template may be used by end users (e.g., clip buyers) to create personalized and customized video clips.

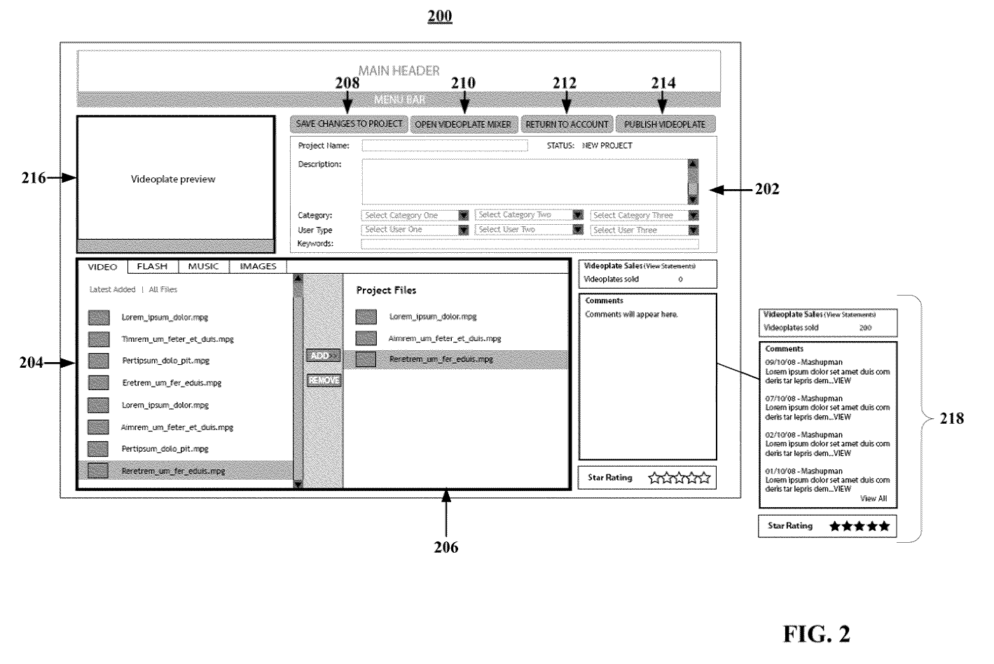

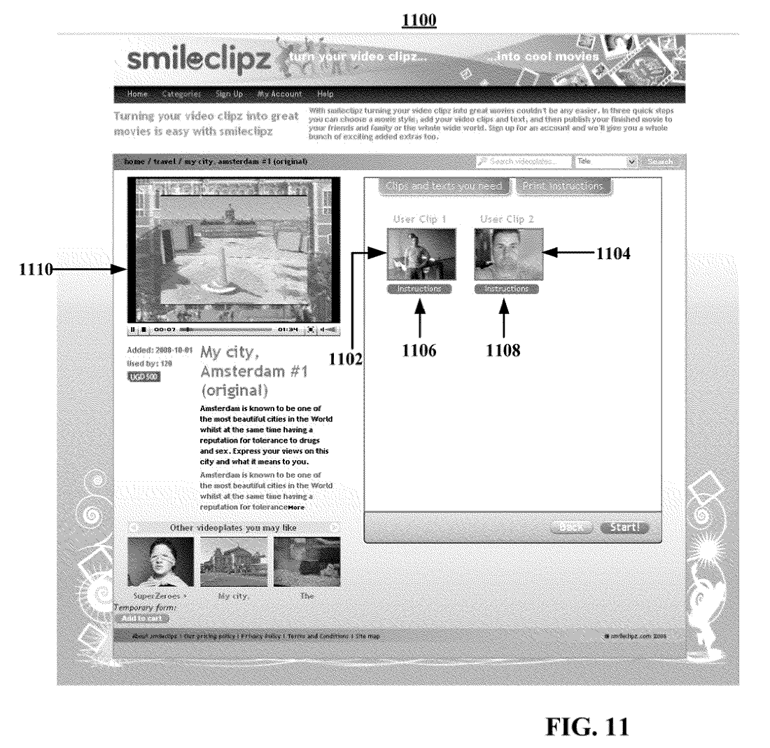

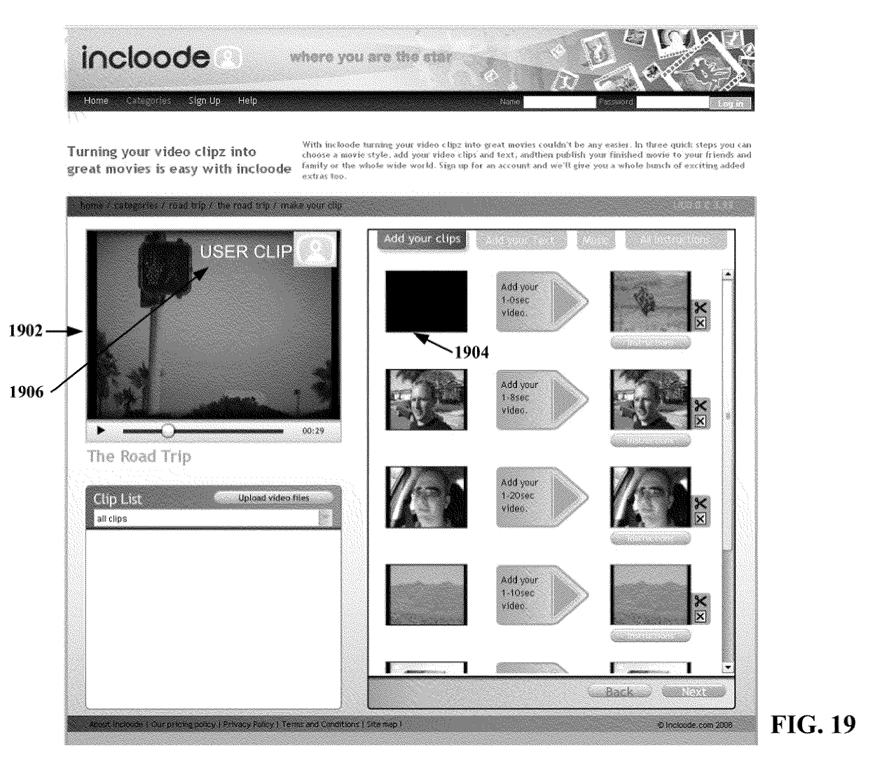

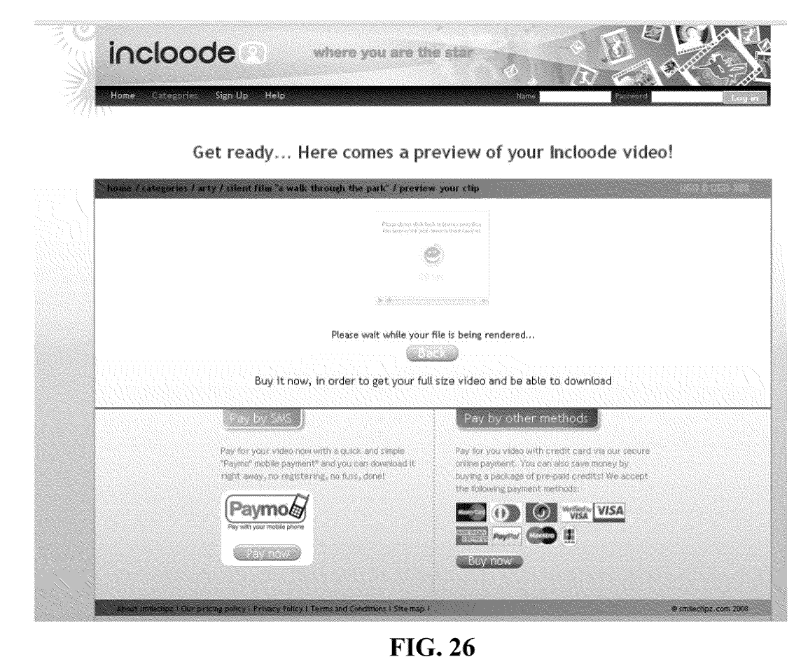

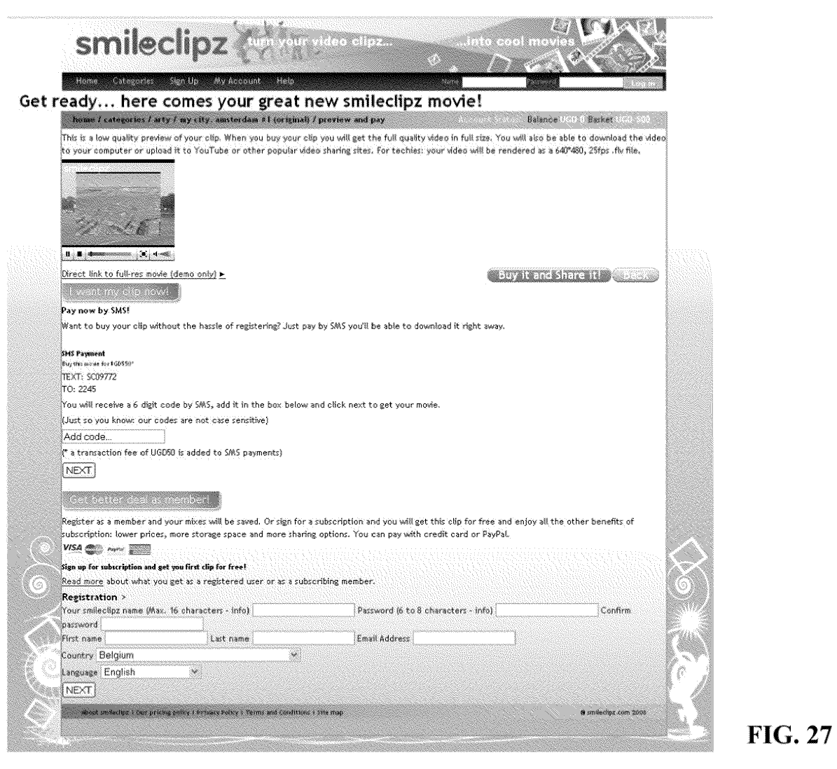

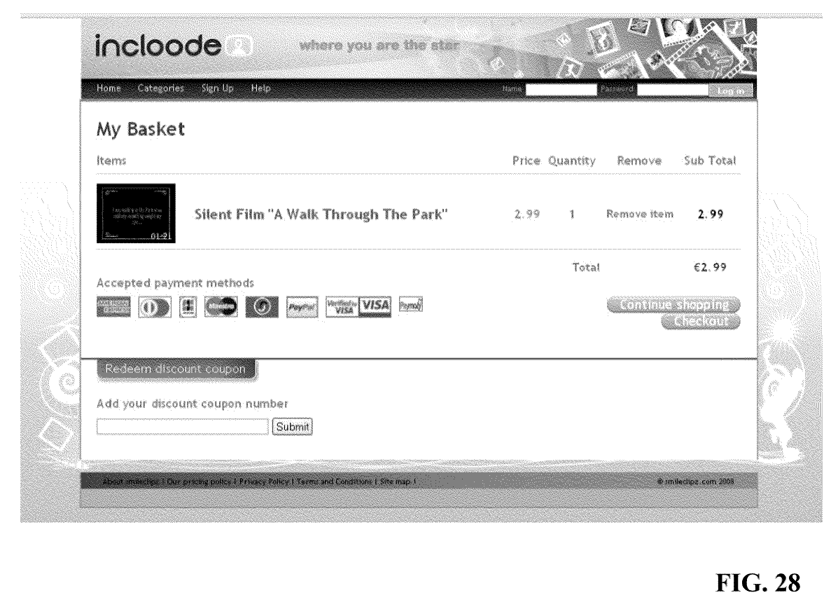

It should be noted that, in some embodiments, the media application may include multiple applications, where one application allows a user to create one or more video templates and another application allows a user to create a customized video clip using a video template. For example, FIGS. 2-9 show illustrative examples of a video template builder interface and FIGS. 11-28 show illustrative examples of a video clip builder interface.

For example, a video artist, a video producer, or any other suitable user may be presented with a video template building interface that includes, among other things, a timeline interface and a media asset interface. The timeline interface includes a plurality of layers (e.g., one or more video layers, one or more audio layers, one or more video effect layers, etc.) in a storyboard format and allows a user to design a video template. The displayed media asset interface allows the user to select from multiple media assets for insertion into the video template. The user, using the timeline interface and the asset interface, may insert and arrange one or more media assets into the video template. For example, the user may define one or more media blocks and assign media assets to each media block. In another example, the user may drag media assets from the asset interface and drop the media assets into particular locations on a layer in the video template. In addition to assigning media assets, the user may set parameters for each inserted media asset (e.g., effects, trim, settings, positioning, etc.). It should be noted that, in some embodiments, visual indicators are displayed along with each media block that indicate the parameters assigned by the user.

It should be noted that examples of such media assets may include, but are not limited to, text, video clips, audio clips, graphical images, still images in sequence, animations, etc.

In some embodiments, the user, using the timeline interface and the asset interface, may request that one of the media blocks (e.g., one that currently includes a particular media asset) be replaced with an end user media block in the video template. End user media blocks may be empty blocks or placeholders that are designated for the insertion of end user-generated video content. In response to replacing a media block with an end user media block in the video template, the media asset assigned to that media block is displayed to the end user as an example of media content suitable for insertion into the end user media block.

In addition to replacing a media block with an end user media block, the user may provide parameters that are associated with the video template (e.g., trim length, effects, playback options, position options, mask options, volume settings, etc.) and instructions that are associated with the user media block. The instructions provide an end user with directions for generating video content suitable for insertion into the end user media block and are displayed with the video template for the end user. For example, instructions may be displayed in response to selecting the video template, where a video artist may instruct the end user to use a video camera to record a particular scene and provide a script to be read while the scene is being recorded.

For example, an end user (e.g., a clip buyer) may create a video clip by selecting the video template from multiple video templates (e.g., a catalogue of video templates that includes descriptions, ratings, and examples of video clips), upload video clip or any other suitable media created by that end user and insert the media into the end user media block of the video template, select one or more parameters relating to the video template (e.g., change texts, select audio, etc.), select to render the video clip, send a payment for the video clip, and obtain a full quality version of the video clip for distribution by the end user, uploading onto a video sharing website, uploading onto a social networking website, etc.

In some embodiments, the parameters may manipulate the user-generated video content. It should be noted that the parameters may include, for example, playback speed, video settings, zoom, screen position, a start time, an end time, transparency, a video effect, and/or user video options. For example, the user may provide parameters that require that particular media assets be displayed at particular times. In another example, the user may provide parameters that allow the end user to select a desired media effect (e.g., allow end users to select whether the portion of the video clip is displayed in slow motion or normal speed).

These mechanisms may be used in a variety of applications. For example, video templates may be used by end users to create and distribute personalized and customized video clips for other websites (e.g., social networking websites) and mobile devices (e.g., video messaging) without end users having the requisite creative and technological expertise. In another example, users may create, distribute, and be rewarded for developing video templates. Each video template created by a user may be tracked and an account of the user may be credited in response to end users selecting a video template, end users creating a video clip with the video template, etc. Each video template may also be rated (e.g., by peers, by end users, etc.). In this way, users (such as those capable of using Final Cut Pro, Adobe Premier, Avid, and/or other video editing applications) may be incentivized to create video templates. In yet another example, a user (e.g., a video producer) may have the desire and the talent to direct and produce a video with a particular storyboard (e.g., defined script, scenes, audio, background music, actors, etc.). Due to a lack of funds, budget constraints, or a lack of interest from investors or backers, the user, using the media application, may create a video template for distribution to show off their artistic talent to peers, investors, and other users.

While the present invention is generally described to be used for creating video templates that are used for creating various customized video clips, this is only illustrative. These mechanisms may be used, for example, to create resume templates or job templates for online recruitment websites, dating profile templates for online dating websites, automobile templates for electronic commerce websites, destination templates for online travel websites, game specific templates for online gaming websites, etc.

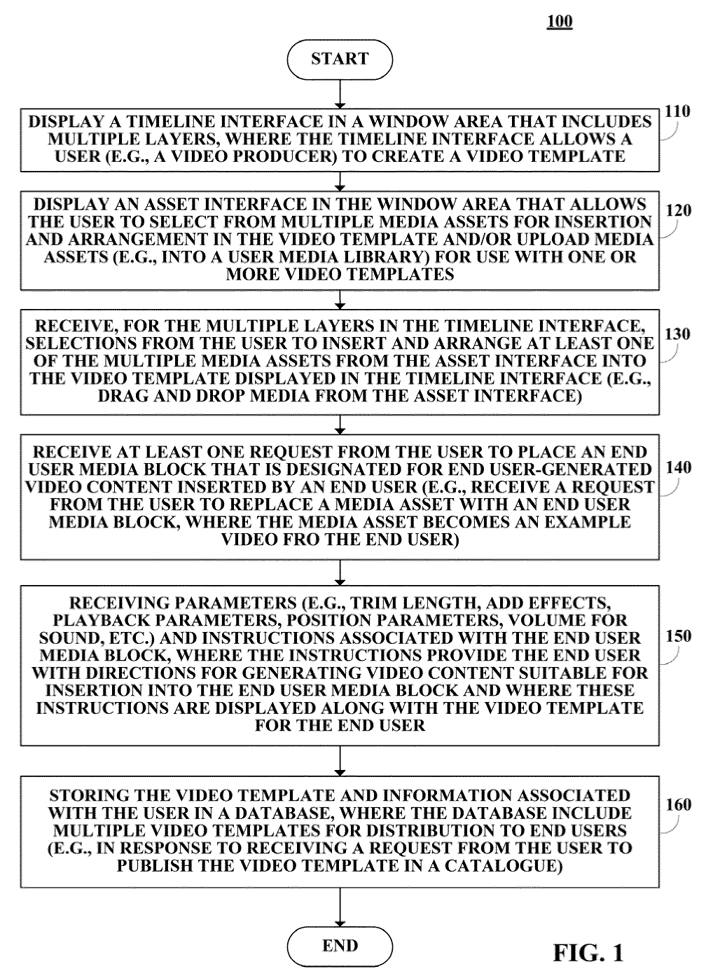

In accordance with some embodiments, a video template may be created and stored using a process 100 as illustrated in FIG. 1. As shown, in response to initiating the media application (e.g., the video template builder portion of the application), the application displays a timeline interface in a window area that allows a user to create a video template at 110 and displays an asset interface in the window area that allows the user to select from multiple media assets for insertion and arrangement into the video template at 120. For example, the application may allow the user to select from media assets stored on a user device and upload select media assets to a user media library for use with one or more video templates.

As illustrated in FIGS. 2-6, the application may display various interfaces and/or screens to the user for creating a video template in accordance with some embodiments of the present invention.

For example, FIG. 2 shows an example of a video template producer project interface 200 that may be displayed to the user in response to initiating the media application. In some embodiments, video template producer project interface 200 may be displayed to the user in response to receiving an indication from the user to start constructing a new video template. As shown, the user is provided with description window 202 that allows the user to describe the video template. Description window 202 includes fields for inputting a title for the video template, a detailed description of the video template, key characteristics of the video template (e.g., number of end user-generated video clips, number of actors or actresses, etc.), one or more categories associated with the video template (e.g., comedy, romance, relationship, artsy, travel, etc.), one or more keywords that describe the video template, etc.

In some embodiments, the media application allows the user to add media assets for use with one or more video templates. For example, as shown in FIG. 2, the application may allow the user to drag the file containing the media content from a user device and drop the file into area 206 of the video template. In another suitable embodiment, the application may allow the user to browse through files stored on the user device in area 204 and select a file containing the media content for insertion into area 206 of the video template. In yet another suitable embodiment, the application may search through the user device for files of a particular format (e.g., video files (MPEG-4 format, Audio View Interleave (AVI) format, etc.), Adobe Flash files, music or audio files (MP3 format), image files (JPG format, GIF format, etc.)). The application may then allow the user to select from one or more files of a particular format detected on the user device in area 204 for insertion into area 206, which may be used for insertion into various video templates.

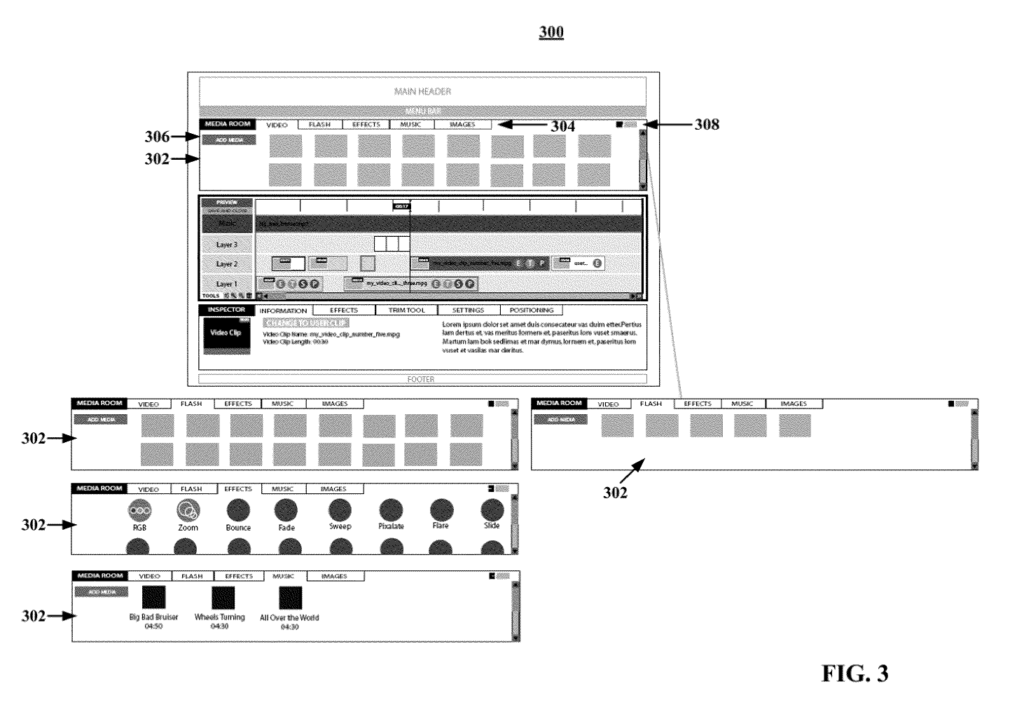

As also shown in FIG. 2, video template producer project interface 200 may includes buttons 208, 210, 212, and 214. Button 208 allows the user to save the current changes to the video template. Button 210 allows the user to enter a mixing interface (e.g., FIGS. 3-6). Button 212 allows the user to review account information. Button 214 allows the user to publish a completed video template. For example, in response to completing a particular video template and pressing button 214, the application may upload the completed video template into a database or publish the completed video template in a catalogue that includes multiple video templates for distribution.

In some embodiments, when video template producer project interface 200 is displayed in response to receiving an indication from the user to edit a video template or an unpublished video template, interface 200 may provide the user with preview 216. Preview 216 may display the last saved version of the video template.

In some embodiments, video template producer project interface 200 may include feedback interface 218. Feedback interface 218 may display feedback and account information associated with the video template displayed in interface 200. For example, feedback interface 218 includes four comments from other users (e.g., peers, other video template producers, end users, etc.), a star rating, and the number of video templates sold by the user to end users. Any other suitable feedback and/or account information may be displayed.

In some embodiments, feedback interface 218 may provide the user with feedback on video templates designed by the user. For example, for each video template designed by the user, feedback interface 218 may show the number of times end users have used the particular video template designed by the user to create a video clip. In addition, for each video template designed by the user, feedback interface 218 may allow end users or any other suitable user to provide comments, rate the user, etc.

It should be noted that video template producer project interface 200 may provide the user with various account features. For example, in response to initiating the media application (e.g., a video producer inputting a username and password on a website) or in response to the user selecting account button 212 of FIG. 2, the application may provide the user with user information (e.g., information relating to the user, such as name, skills, rating, and/or any other suitable user information), user links (e.g., links to websites that are using a video template designed by the user, links to favorite video clips, links to favorite users, links to favorite video templates, etc.), a listing of video templates designed by the user, etc.

In response to, for example, selecting button 210, the application may display an illustrative video template builder screen 300 that includes, among other things, a media asset interface 302. As shown in FIG. 3, media asset interface 302 includes thumbnails for media assets (e.g., video clips, Adobe Flash files, effects, audio files, image files) in a matrix layout.

In response to selecting one of the tabs 304 (e.g., a video tab, a Flash tab, an effects tab, a music tab, and an images tab), media asset interface 302 may display thumbnails for media assets associated with the particular tab. In response to selecting a video tab from tabs 304, media asset interface 302 displays thumbnails of video clips in a matrix layout. Similarly, in response to selecting a Flash tab, media asset interface 302 displays thumbnails of Flash files in a matrix layout. In response to selecting an effect tab, media asset interface 302 may display the effects that may be applied to media assets (e.g., RGB, zoom, bounce, fade, sweep, pixelate, flare, slide, etc.). In response to selecting a music or audio tab, media asset interface 302 may display an icon representing each audio file.

As described previously, the media application may allow the user to add additional media assets (e.g., other video clips, Flash files, audio files, etc.) to a video template. For example, as shown in FIG. 3, media asset interface 302 allows the user to add additional media assets in response to selecting add button 306. The media application may then allow the user to select from one or more files of a particular format detected on the user device for insertion into media asset interface 302, which may be used for insertion into various video templates. In another example, in response to selecting add button 306, the media application may transfer the user to video template producer project page 200 as shown in FIG. 2 to add the additional media assets.

In some embodiments, the media application may allow the user to change viewpoints in media asset interface 302 or any other suitable interface for building a video template. For example, as shown in FIG. 3, button 308 may allow the user to alternate between viewing media assets in a matrix layout and viewing media assets in a list layout.

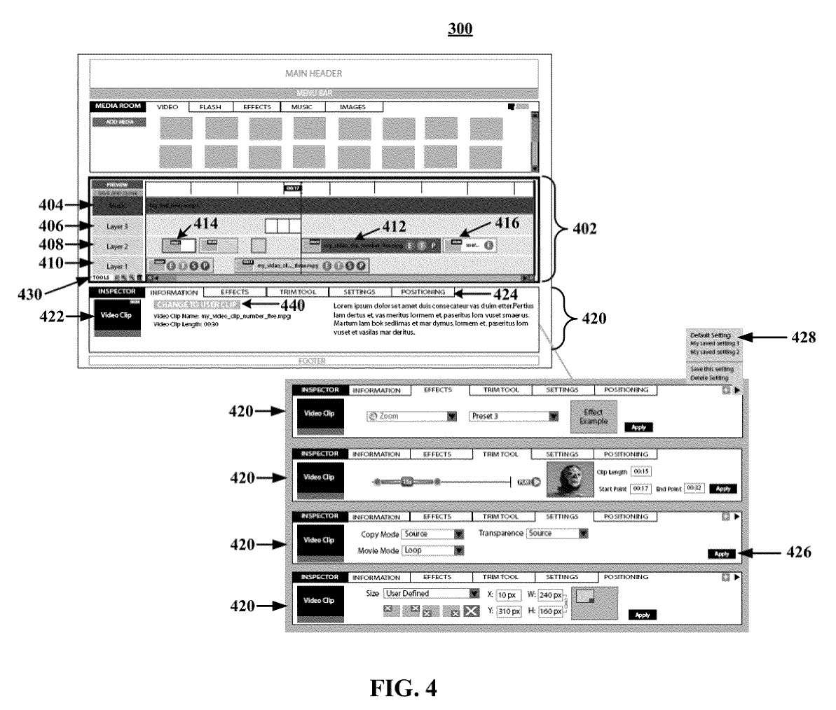

In addition, video template builder screen 300 may also include a timeline interface 402 as shown in FIG. 4. Timeline interface 402 includes multiple layers for inserting and arranging media assets, such as music layer 404 and video layers 406, 408, and 410, into a video template. For example, multiple video blocks (e.g., media block 412) are inserted into layers 404, 406, 408, and 410 of the video template. As shown, the audio clip entitled “big_bad_bruiser.mp3” has been inserted into layer 404. Media block 412 as well as various end user media blocks 414 and 416 have been inserted into layers 408 and 410. Each media block may be assigned a particular media asset from asset interface 302 of FIG. 3. For example, the application may allow the user to select a media asset from asset interface 302 for insertion into a media block placed in timeline interface 402. In another example, the application may allow the user drag a media asset from asset interface 302 and drop the media asset onto an area in timeline interface 402.

It should be noted that the icons or representations of the media assets inserted in timeline interface 402 may include information relating to the media asset in the video template. For example, as shown in FIG. 4, each media block includes the name of the clip (e.g., my_video clip_number_five.mpg), the length of the clip (e.g., thirty seconds), and parameters or settings applied to each clip (e.g., E for effects, T for trim, S for settings, and P for positioning). In another example, media blocks may be shaded or colored differently to differentiate between media types (e.g., audio, video, effects, etc.), different relationships (e.g., parent media blocks and child media blocks), etc.

In some embodiments, the media application may allow the user to view and/or edit parameters or settings associated with each inserted media asset in the video template. As shown in FIG. 4, in response to highlighting or selecting a media block, the media application may provide the user with inspector interface 420. Inspector interface 420 may include a description of the selected media asset, a preview 422 of the selected media asset, and/or any other suitable information.

In response to selecting one of the tabs 424 (e.g., an information tab, an effects tab, a trim tool tab, a settings tab, and a positioning tab), inspector interface 420 may allow the user view information relating to the media asset in the video template, apply one or more effects to the media block, trim the length and time sequence of the media block, change mask settings or any other suitable settings associated with the media block, and/or change positioning information associated with the media block. For example, in response to selecting an effects tab from tabs 424, inspector interface 420 displays parameters for applying an effect to the media block (e.g., RGB, zoom, bounce, fade, sweep, pixelate, flare, slide, etc.) and an example of the selected effect. In response to selecting a trim tool tab from tabs 424, inspector interface 420 displays parameters for editing the length of the media block (e.g., in seconds), the start time and end time of the media block, etc. In response to selecting a settings tab from tabs 424, inspector interface 420 displays options for changing mask settings associated with the media asset (e.g., copy mode, movie mode, transparency, etc.). In response to selecting a positioning tab from tabs 424, inspector interface 420 displays settings for altering the size, orientation, and positioning of the media asset on the video template.

In response to selecting any of tabs 424 and editing parameters or settings associated with an inserted media asset in the video template, the media application may request that the user select an apply button 426 or any other suitable interface to confirm and apply the edited settings.

In some embodiments, the media application may allow the user to save particular parameters or settings for use with other media assets in the video template or other video templates. For example, in response to creating a particular effect for a media asset, the user may retain the settings that created the particular effect for use on a similar media asset in a different video template. These saved settings may be displayed, for example, in area 428.

In some embodiments, the media application may allow the user to remove media blocks from timeline interface 402 (e.g., using button 430). In response to selecting an inserted media asset in the video template and pressing delete button 430, the application may display a warning indicator that prompts the user for confirmation. As described herein, end user media blocks may include parent end user media blocks and children end user media blocks. In response to deleting a parent end user media block, each child end user media block related to the parent end user media block may also be deleted.

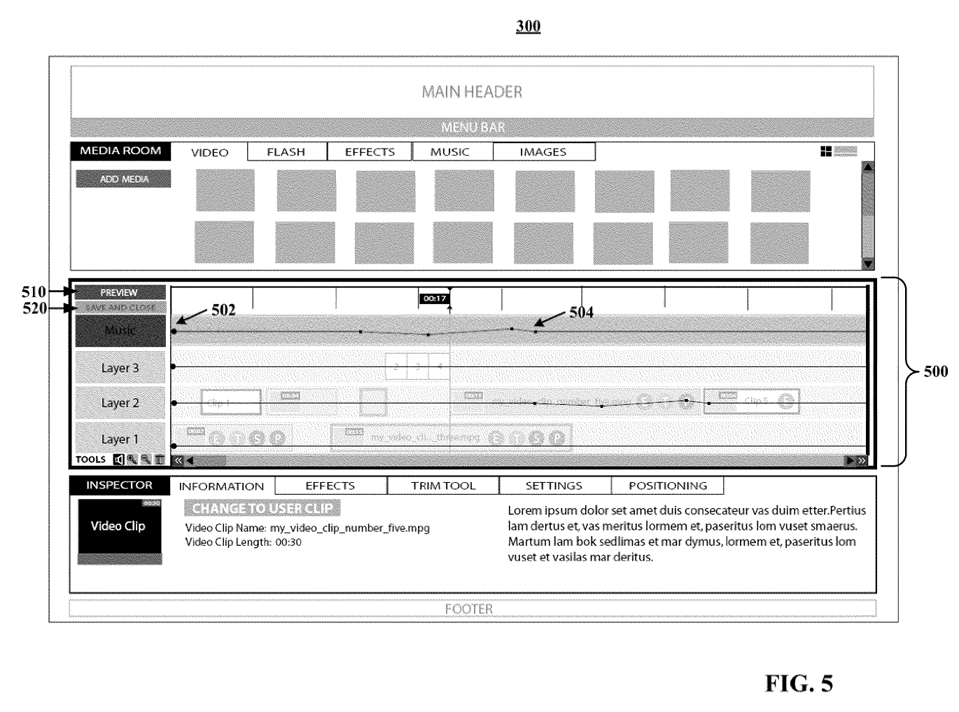

In some embodiments, the media application may allow the user to change timeline interface 402 into a volume interface 500 to view and/or edit the volume profiles associated with each layer in the video template. As shown in FIG. 5, volume interface 500 includes one or more anchor points for each layer. An anchor point at the beginning of a layer, such as anchor point 502 may be raised or lowered by the user to control the overall volume of the media assets in that layer. In some embodiments, additional anchor points may be inserted into each layer by selecting a point along the volume profile for that layer. For example, in response to using a user input device and clicking a point along the volume profile, anchor point 504 is added. Anchor point 504 may be used to create fade ins or fade outs for the particular layer.

It should be noted that timeline interface 402 and/or volume interface 500 may include preview button 502 and save button 504. In response to selecting preview button 502, the application may display a preview of the current version of the video template. For example, the application may dim video template builder screen 300 with a grey tint and display a media player window that provides a preview of the video template. In response to selecting save button 504, the application may save the current version of the video template and return the user to video template producer project interface 200 (FIG. 2).

In some embodiments, the application may allow the user to replace or convert a media block into an end user media block in the video template. End user media blocks may be empty blocks or placeholders that are designated for the insertion of end user-generated video content. In response to replacing a media block with an end user media block, the media asset assigned to that media block is displayed to the end user as an example of media content suitable for insertion into the end user media block.

For example, referring back to FIG. 4, in response to the user selecting button 430, the application replaces the selected media block with an end user media block in the video template. It should be noted that, in some embodiments, the first end user media block is designated as a parent end user media block and subsequent end user media blocks are designated as child end user media blocks. However, any suitable relationship indicators may be associated with end user media blocks (e.g., the application may allow the user to designate one of the end user media blocks as the parent end user media block).

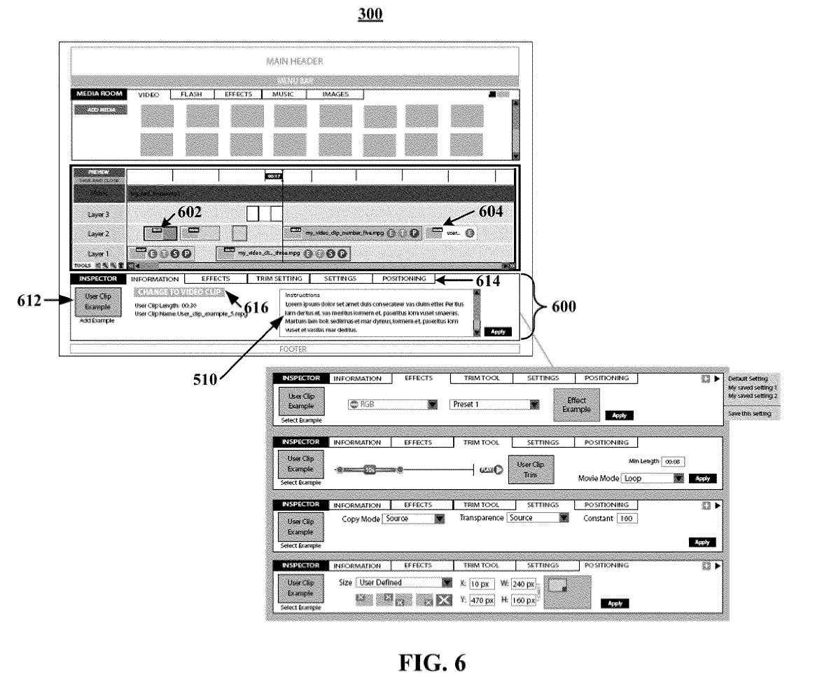

As shown in FIG. 6, two end user media blocks 602 and 604 have been inserted into Layer 2 of the video template. In response to highlighting parent end user media block 602, the media application may allow the user to view and/or edit parameters or settings associated with the end user media block. For example, in response to highlighting or selecting an end user media block, the media application may provide the user with inspector interface 600.

In some embodiments, inspector interface 600 may include instructions 610 that provide an end user with directions for generating video content suitable for insertion into the end user media block and are displayed with the video template for the end user. For example, instructions 610 may be displayed in response to selecting the video template, where a video artist may instruct the end user to use a video camera to record a particular scene and provide a script to be read while the scene is being recorded.

In some embodiments, inspector interface 600 may include example 612 that provide an end user with an example of content suitable for insertion into the end user media block in the video template. For example, in some embodiments, the media asset assigned to that media block may be displayed to the end user as an example of media content suitable for insertion into the end user media block. Alternatively, the application may allow the user to upload one or more examples to display to the end user.

In some embodiments, the application may allow the user provide parameters and/or settings that manipulate the user-generated video content for insertion into one or more end user media blocks in the video template. It should be noted that the parameters may include, for example, playback speed, video settings, zoom, screen position, a start time, an end time, transparency, a video effect, size, layer priority, loop, mode, and/or user video options.

Similar to inspector interface 420, in response to selecting one of the tabs 614 (e.g., an information tab, an effects tab, a trim tool tab, a settings tab, and a positioning tab), inspector interface 614 may allow the user view information relating to the end user media block in the video template, apply one or more effects to the content inserted into the end user media block, trim the length and time sequence of the content inserted into the end user media block, change mask settings or any other suitable settings associated with the content inserted into the end user media block, and/or change positioning information associated with the content inserted into the end user media block.

Similar to button 440 of FIG. 4, the application may allow the user to convert user media block back to the media block that includes the selected media asset. For example, instead of requesting that an end user input end user-generated media content, the user may insert a media asset for playback in the one or more customized video clips created using the video template.

It should be noted that, in response to highlighting parent end user media block 602 in the video template, the application may also highlight child end user media blocks, such as child end user media block 604 (e.g. in a different color, with a different shading, etc.).

Generally speaking, the application allows the user to create video templates, where the user may define or pre-populate the template with media assets, define effects, positions, and/or other media options for the media assets, define positions for end user-generated media may be added, define instructions as to how the end user should generate the video content for insertion into the video template, and define how the media assets and the end user-generated media are mixed together.

Referring back to FIG. 1, in response to displaying a timeline interface and an asset interface for creating a video template, the application may receive a number of instructions from the user. At 130, the application may receive, for the multiple layers in the timeline interface, selections from the user to insert and arrange one or more media assets from the asset interface into the video template. As described previously, FIGS. 2-6 illustrate that the application allows the user to insert media blocks into particular layers, where each media block may be assigned a particular media asset from the asset interface.

In some embodiments, the application may allow the user to replace an inserted media block with an end user media block that is designated for end user-generated video content inserted by an end user at 140. As described previously, end user media block may be an empty media block or a placeholder for end user-generated video content. For example, the user may replace an inserted media block with an empty media block that specifies where the end user is to insert a video clip.

In some embodiments, the application provides the inserted media block that was replaced with an end user media block as an example of media content suitable for insertion into the end user media block. Alternatively, the application may allow the user to upload one or more examples of media content suitable for insertion into the end user media block to display to the end user.

In addition, at 150, the application may receive parameters associated with the video template and instructions associated with the end user media block. The user may provide parameters and/or settings that modify particular media blocks, end user media blocks, and/or the entire video template. The parameters may include, for example, effects, trim, mask information, positioning information, playback speed, video settings, start time, end time, transparency, video effects, etc.

In some embodiments, the instructions associated with the end user media block provide the end user with directions for generating video content suitable for insertion into the end user media block. These instructions are generally displayed along with the video template selected by the end user. The instructions provided by the user may direct the end user to, for example, record a particular scene (e.g., two actors speaking with each other) with a script provided by the user in the instructions, particular actions being performed by the actors in the video clip, particular sound being heard in the background, etc. Generally speaking, the user may provide instructions that allow the end user to seamlessly insert a video clip into the video template without the end user performing any video editing, mixing, and/or producing techniques to the end user-generated media.

Upon completing the video template, the video template and information associated with user (e.g., the video producer that created and produced the video template) may be stored in a database or any other suitable storage device. In some embodiments, the database aggregates the video templates received from users for distribution to end users (e.g., clip buyers). In another embodiment, the database creates a catalogue of published or completed video templates for selection by end users.

In some embodiments, the database may be connected to one or more content distributors or content aggregators (e.g., Amazon.com, Match.com, movieclip.com, search engines, etc.). Content distributors (e.g., a web server operated by a host, such as Match.com) may receive video templates from the database. In some embodiments, content distributors may receive a notification when updated or new video templates have been uploaded into the database. In some embodiments, the database may maintain an index that references the video templates from the database. Content distributors may retrieve the index from the database to determine whether to receive updated or new video templates from the database.

In some embodiments, the application may aggregate the video templates created by users into a catalog of video templates. For example, the application may allow any suitable user to create a video template using the video template builder application in order to build a catalog of video templates.

It should be noted that, in some embodiments, the application may track each video template and provide a payment (e.g., monetary payment, credit, social credit, etc.) to the user that designed the video template. For example, for a video clip created using a video template and purchased by an end user, the application may provide the user that designed the video template with at least a portion of the purchase price paid by the end user. In another example, in response to the sale of ten video clips created using a video template, the application may provide the user that designed the video template with a free promotion on a website (e.g., a top designer promotion). In some embodiments, the application may request that content distributors track the usage of each video template in order to provide a partial payment to the user that designed the video template.

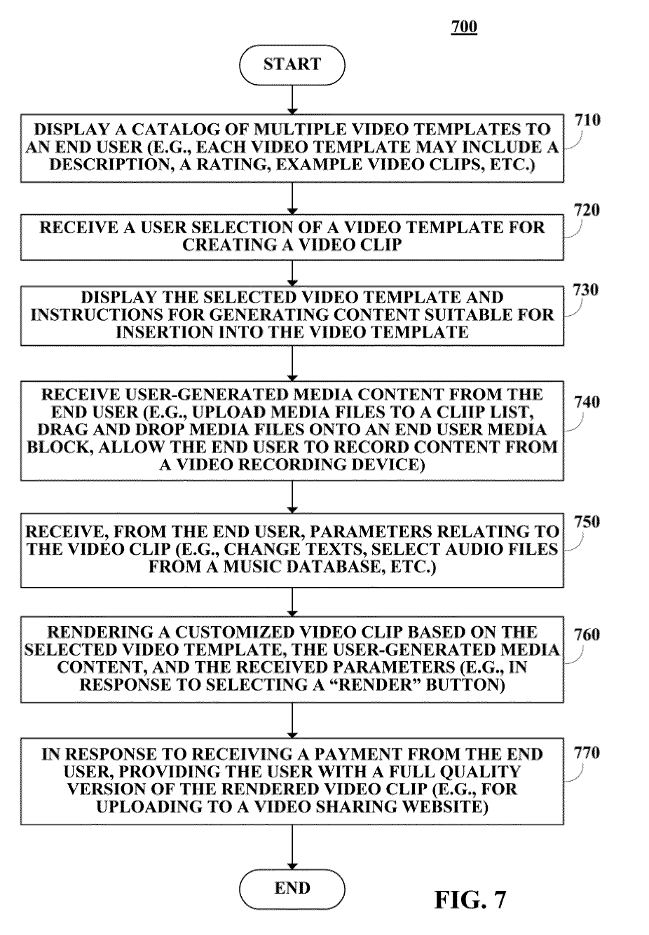

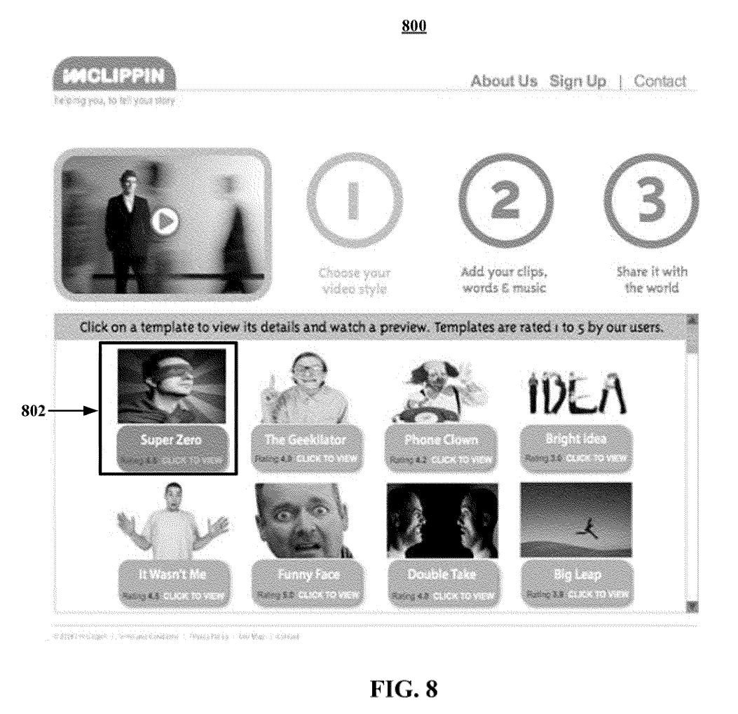

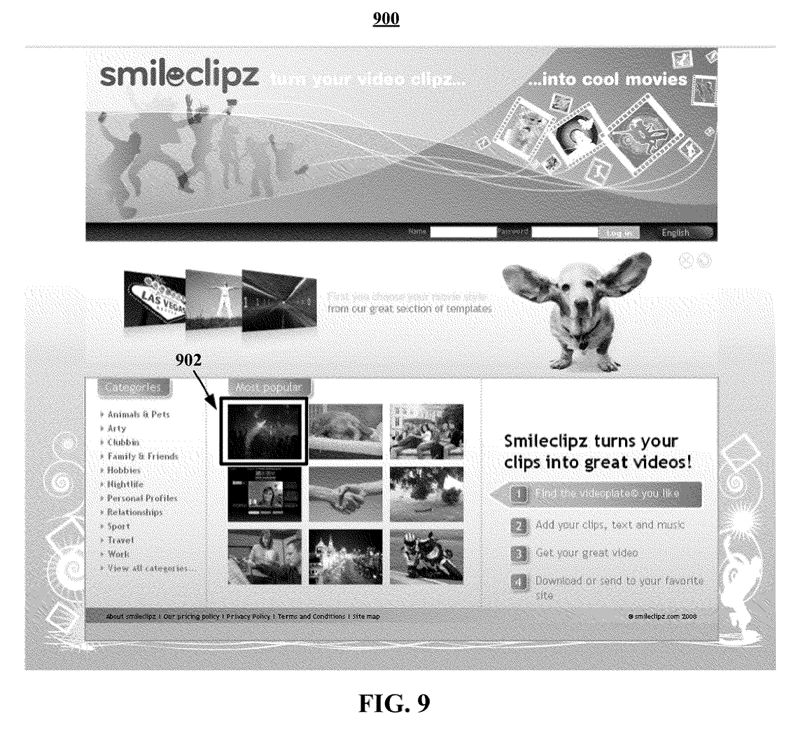

In accordance with some embodiments, one or more customized video clips may be created using a video template using a process 700 as illustrated in FIG. 7. As shown, in response to initiating the media application (e.g., the clip builder portion of the application), the application displays representations (e.g., icons, screenshots, etc.) of multiple video templates to an end user at 710. The video templates, representations of each video template, and information associated with each video template are retrieved from a database. For example, as shown in FIGS. 8 and 9, illustrative template selection interfaces 800 and 900 are displayed that allow an end user to select a video template from multiple video templates.

In each of interfaces 800 and 900, each video template is represented by an icon, animation, series of images, or any other suitable graphic (e.g., representations 802 and 902). For example, in some embodiments, in response to an end user placing a highlight region or a pointer of a user interface device (e.g., a mouse) over a particular video template, the application may provide a preview or a series of images of the highlighted video template. In another example, in response to an end user placing a highlight region over a particular video template, the application may provide an information window that describes the video template, the creator of the video template, etc.

In some embodiments, the application may assist the end user in selecting a video template. For example, as can be seen in FIGS. 8 and 9, video templates may be organized by category (e.g., animals and pets, family and friends, hobbies, nightlife, travel, sports, relationships, work, etc.). In another example, video templates may be organized by user (e.g., by producer) or any other suitable criteria. As also shown in FIGS. 8 and 9, the application may provide information associated with each video template to assist the end user in selecting a video template. For example, each representation of a video template may include a user rating, a peer rating, or any other suitable rating information. In another example, a list of the most popular video templates selected by end users may be displayed.

Referring back to FIG. 7, in response to receiving a user selection of a video template for creating a video clip at 720, the application may display the selected video template and instructions for generating media content suitable for insertion into an end user media block at 730. As described previously, end user media blocks may be empty blocks or placeholders for end user-generated video content. For example, an end user (e.g., a clip buyer) may create a video clip by selecting the video template from multiple video templates, inserting a video clip or any other suitable media created by that end user into the end user media block of the video template.

The instructions provide the end user with directions for generating video content suitable for insertion into the end user media block of a video template. For example, instructions may be displayed in response to selecting the video template, where a video artist may instruct the end user to use a video camera to record a particular scene and provide a script to be read while the scene is being recorded. In response to following the instructions for generating content suitable for the end user media block, the application may receive the end user-generated content (e.g., a video clip, etc.) at 740.

In some embodiments, the application may receive parameters from the end user that modifies the video clip at 750. The parameters may include, for example, playback speed, video settings, zoom, screen position, a start time, an end time, transparency, a video effect, and/or user video options.

For example, as shown in FIGS. 8-24, interfaces are provided for displaying the video template and assisting the end user generate media content suitable for insertion into the video template and create a video clip (e.g., a professional video clip).

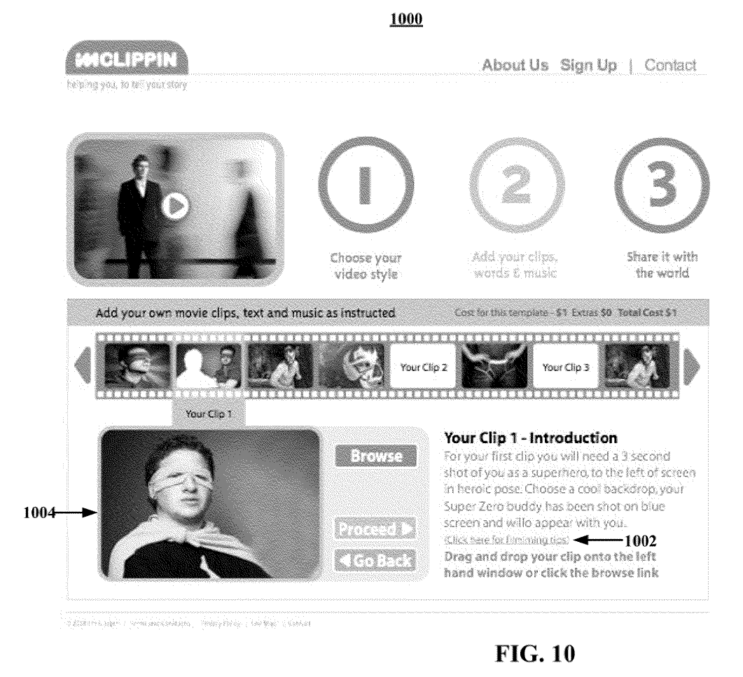

FIGS. 10-12 show illustrative interfaces for directing the production and insertion of end user-generated media content in accordance with some embodiments. As shown in FIG. 10, interface 1000 includes a general overview of the story behind the video template. In addition, the general overview includes a description of the media content that the end user is to create for insertion into the video template. For example, in response to clicking on link 1002, the application may provide the end user with specific instructions on how to create content suitable for insertion into the video template. In another example, the application may provide the end user with the number of video clips that the end user has to create, the number of actors or actresses required, any special props required, etc. The instructions may direct the end user to record a particular scene (e.g., two actors speaking with each other) with a script provided by the user in the instructions, particular actions being performed by the actors in the video clip, a particular sound being heard in the background (e.g., a whistling tea kettle), particular instructions for holding a camera, filming device, or any other suitable media capturing device (e.g., point it towards the sky, rotate the camera 45 degrees with respect to the tree in the background, particular music being played in the background, etc.

In response to creating the end user-generated media content, the application may allow the end user to insert the media content into area 1004. For example, in some embodiments, the application may allow the end user to drag the file containing the media content from an end user device and drop the file into area 1004. In another suitable embodiment, the application may allow the end user to browse through files stored on the end user device and select a file containing the media content for insertion into area 1004. In yet another suitable embodiment, the application may search through the end user device for files of a particular format (e.g., MPEG-4 format, Audio View Interleave (AVI) format, etc.). The application may then allow the end user to select from one or more files of a particular format detected on the end user device.

Similarly, as shown in FIG. 11, the application may provide the end user with an interface 1100 that describes the selected video template and allows the end user to insert multiple pieces of end user-generated media content 1102 and 1104. For example, the video template entitled “My city, Amsterdam #1 (original)” may request that the end user generate two media clips with specific instructions for creating the two media clips (e.g., instructions 1106 and 1108).

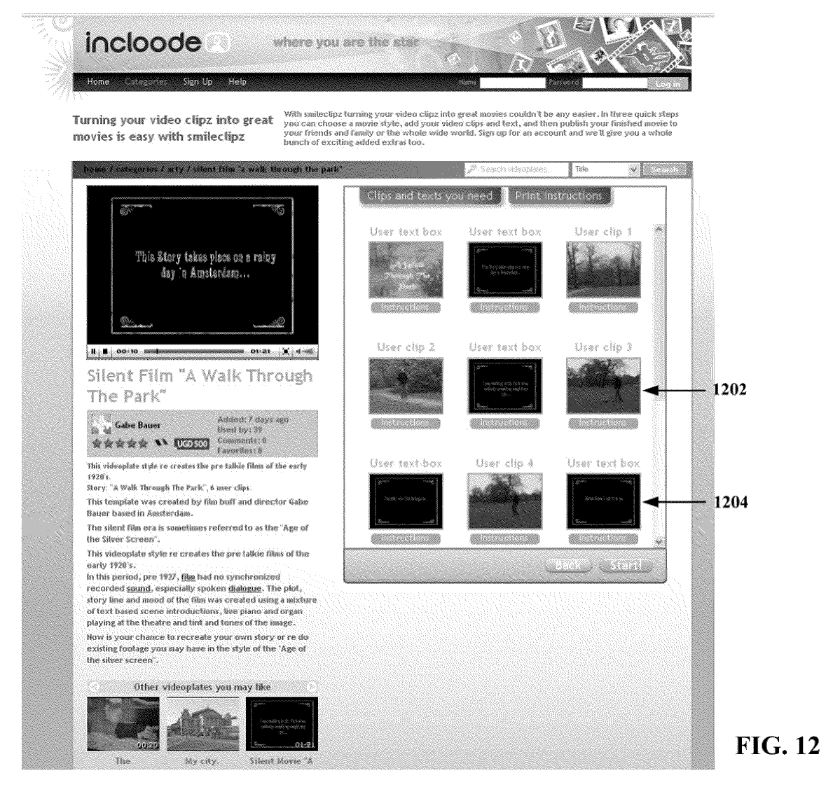

In some embodiments, the application may request that the end user generate different types of content for end user media blocks. For example, as shown in FIG. 12, end user-generated media content 1202 is a user-generated video clip, while end user generated media content 1204 is a user-generated clip with text.

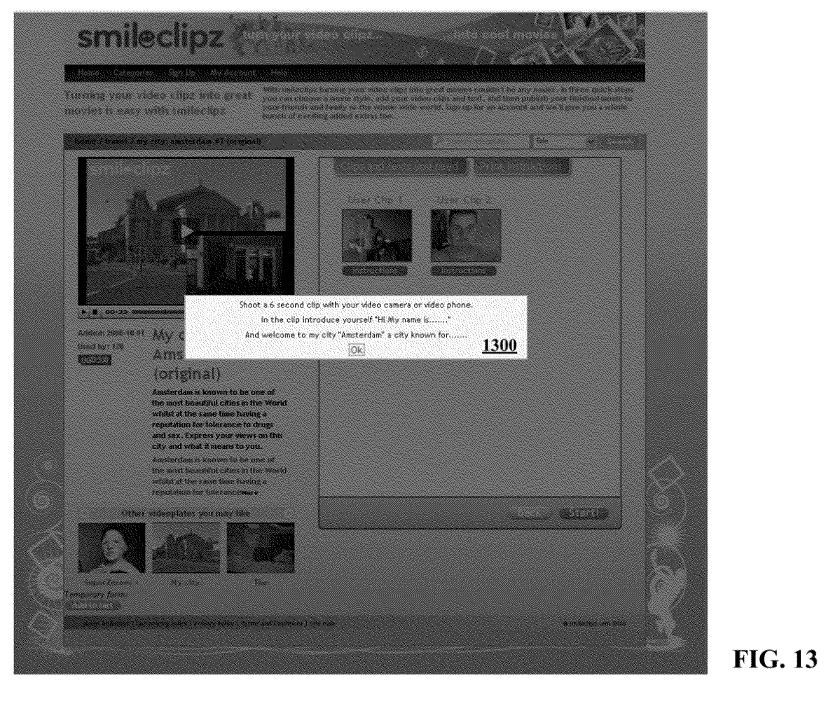

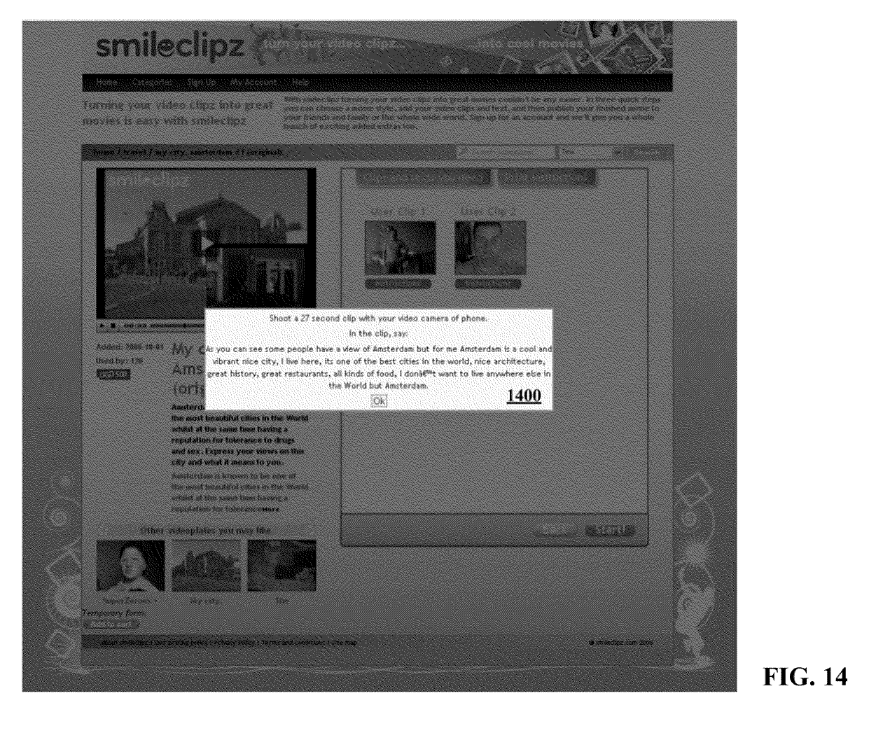

Examples of the instructions that are provided to the end user for producing and creating media content suitable for insertion into the video templates are provided in FIGS. 13 and 14. For example, in response to the end user selecting instructions button 1106 in FIG. 11 (or any other suitable user interface), the application may provide the end user with instructions 1300 shown in FIG. 13. As shown, the instructions direct the end user to create a six second video clip, where the end user introduces himself or herself and provides a welcome message in accordance with the provided script. In another example, in response to the end user selecting instructions button 1108 in FIG. 11 (which corresponds to the second media clip 1108), the application may provide the end user with instructions 1400 shown in FIG. 14. As shown, these instructions direct the end user to create a twenty-seven second video clip of the end user communicating a message in accordance with the provided script.

It should be noted that the instructions provided to the end user may include any suitable instructions. For example, the video template may request that the end user produce and record ten scenes with various actors, lines and/or scripts, music, etc. In another example, the video template may request that the end user use particular modes and/or settings (e.g., black and white mode, sepia mode, slow motion, change the video quality to 30 frames per second, etc.) on the video capture device or any other suitable device or recording the end user-generated media content.

In some embodiments, the application may analyze the received end user-generated media content to ensure it complies with the instructions from the user. For example, the application may transmit the end user-generated media content to a voice recognition application that determines whether the end user provided the correct script and/or voiceovers to the media content. In response to determining that the end user has not complies with the instructions from the user that created the video template, the application may inhibit the end user from inserting the end user-generated media content. Alternatively, using the voice recognition application, the application may provide the end user with recommendations on how to produce media content that complies with the instructions.

Referring back to FIG. 11, in some embodiments, the application may provide the end user with a preview of the end user-generated media content that has been inserted into the video template in preview area 1110. For example, the end user may review the end user-generated media content that has been mixed into the video template to determine whether to re-shoot the end user-generated media content. Alternatively, preview area 1110 may provide the end user with a preview of the video template, where the end user-generated media blocks are left empty. In yet another embodiment, preview area 1110 may provide the end user with a preview of the video template, where an example of media content is inserted into the end user media blocks.

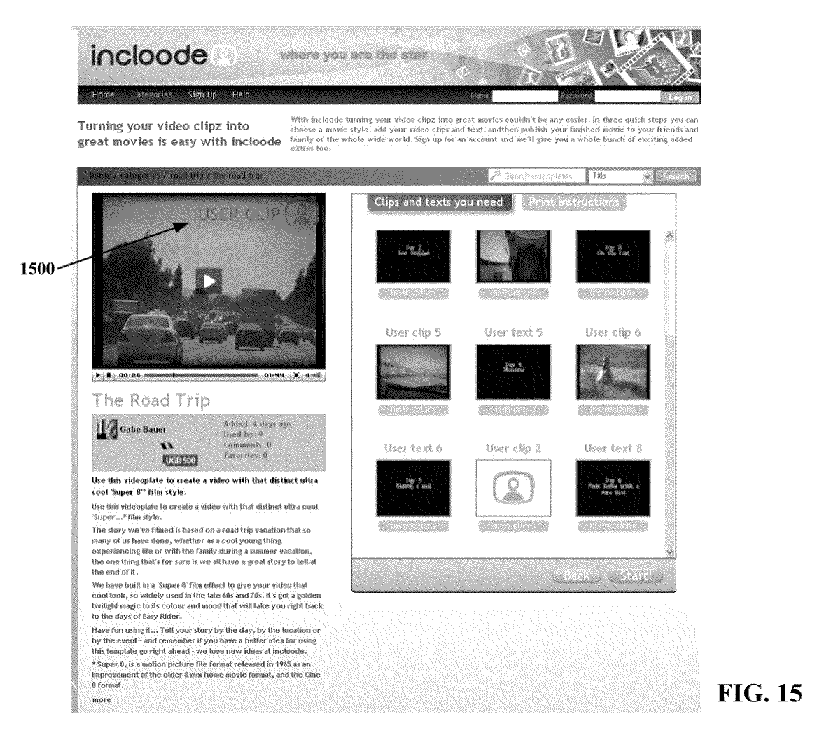

For example, as shown in FIG. 15, the application provides the end user with a preview of the video template, where examples of media content are inserted into each of the end user media blocks. As illustrated, the preview and/or any other suitable example of media content may include an indicator 1500. Indicator 1500 provides the end user with an indication that the displayed media content (e.g., a video clip) is to be replaced with end user-generated media content. Indicator 1500 may include, for example, a logo, a warning message (“replace this clip”), an identifier (“user clip”), an icon, and/or any other suitable content.

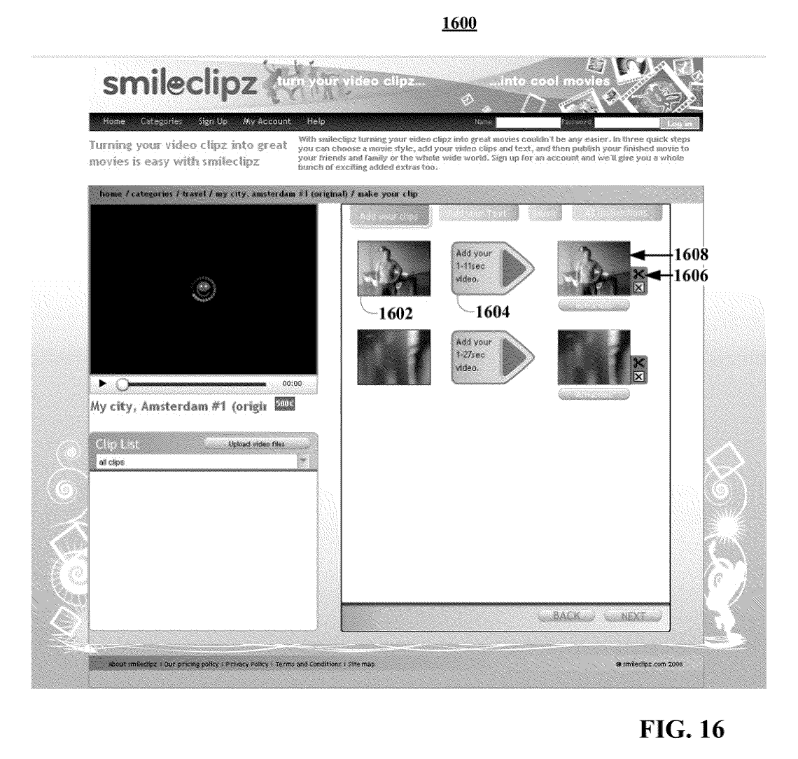

In some embodiments, the application may allow the end user to edit the end user-generated media content using the application. For example, the application may initiate a video editing application that allows the end user to perform one or more operations on the end user-generated media content (e.g., trim, crop, brightness, zoom, focus, etc.). As shown in FIG. 16, the application provides the end user with interface 1600, which requests that the end user insert media content into an area 1602. All or a portion of instructions are provided in area 1604 to direct the end user to provide media content suitable for the selected video template. In response to selecting an editing button 1606, the application may initiate a video editing application that allows the end user to manipulate and/or edit the end user-generated media content inserted into area 1602. A preview or a screenshot of the edited media content may be displayed in area 1608.

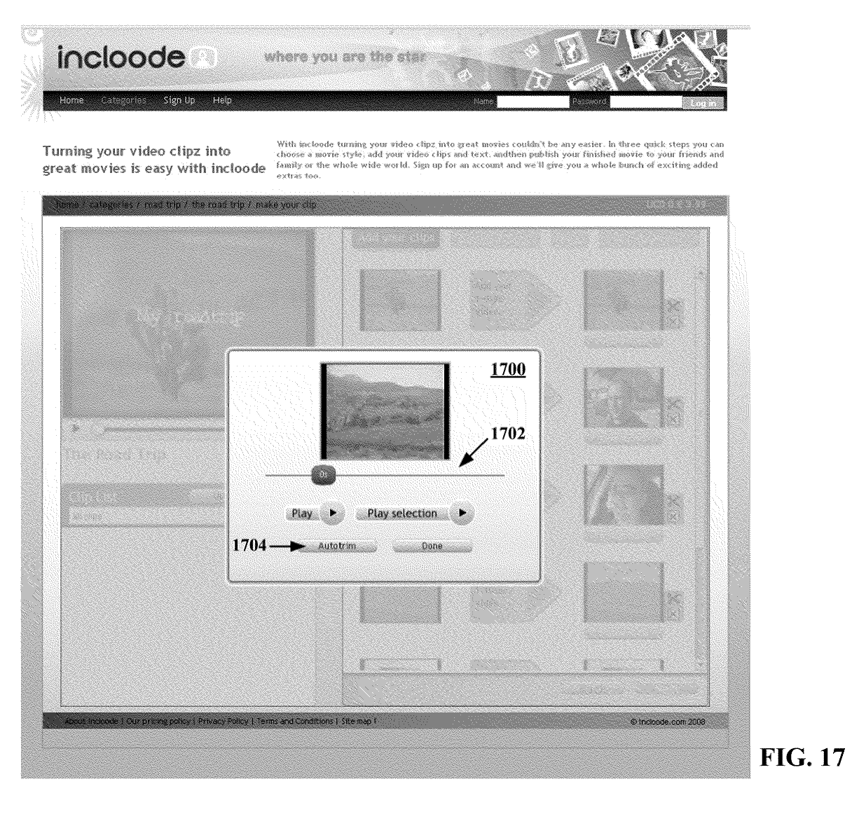

For example, as shown in FIG. 17, the application may provide the user with editing interface 1700 in response to selecting editing button 1606 of FIG. 16. As shown, the application may provide the user with various editing options 1702 for trimming the inserted end user-generated media content. In some embodiments, the application may also provide the user with an option 1704 that automatically edits and/or trims the end user-generated media content. It should be noted, however, that any suitable options for editing the end-user generated media content may be provided to the user. For example, the application may allow the user to crop, brighten, zoom, focus, change the resolution, change the volume of the audio, etc.

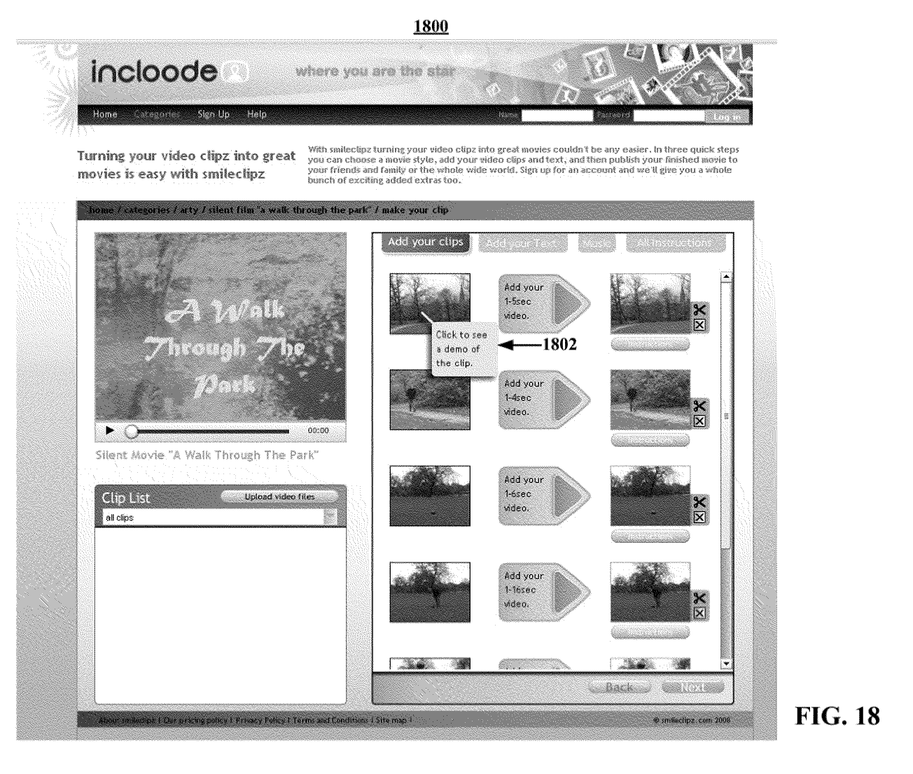

Alternatively, in FIG. 16, the application may provide the end user with area 1602 that displays an example of media content suitable for insertion into the particular end user media block. In response to inserting end user-generated media content, the content may be displayed in area 1608. For example, as shown in FIG. 18, in response to placing a pointer or other suitable user interface over area 1602, the application displays message 1802, which indicates that area 1602 shows a demonstration or an example of a video clip suitable for insertion by the end user.

As described previously, the application may provide the end user an indicator that indicates when displayed media content (e.g., a video clip) is to be replaced with end user-generated media content. For example, in preview window 1902 and 1904, an indicator 1906 may be provided that includes a logo, a warning message (“replace this clip”), an identifier (“user clip”), an icon, and/or any other suitable content.

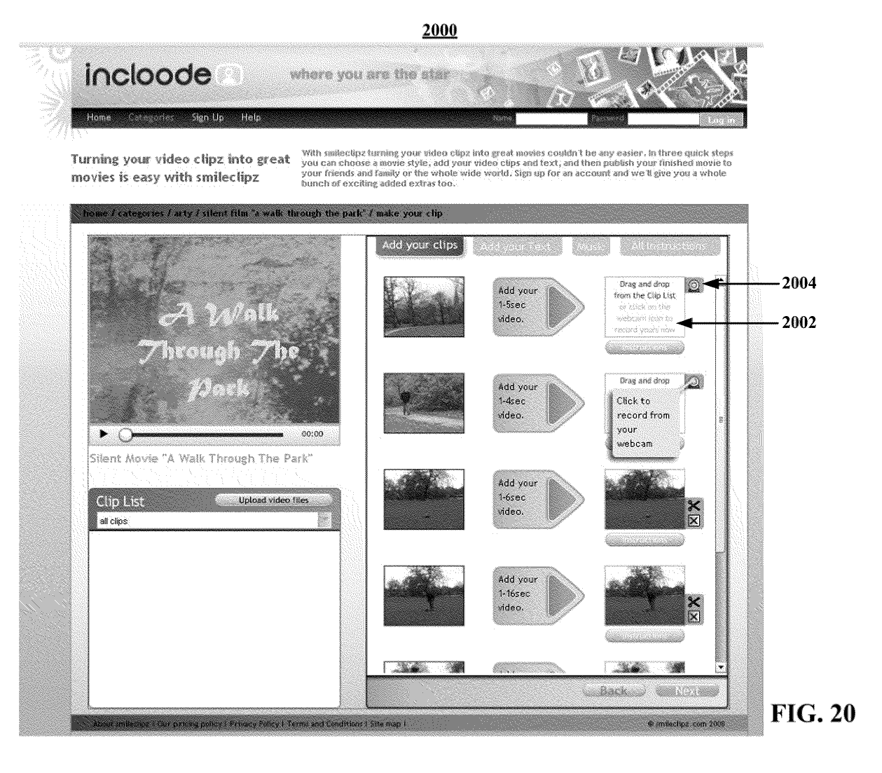

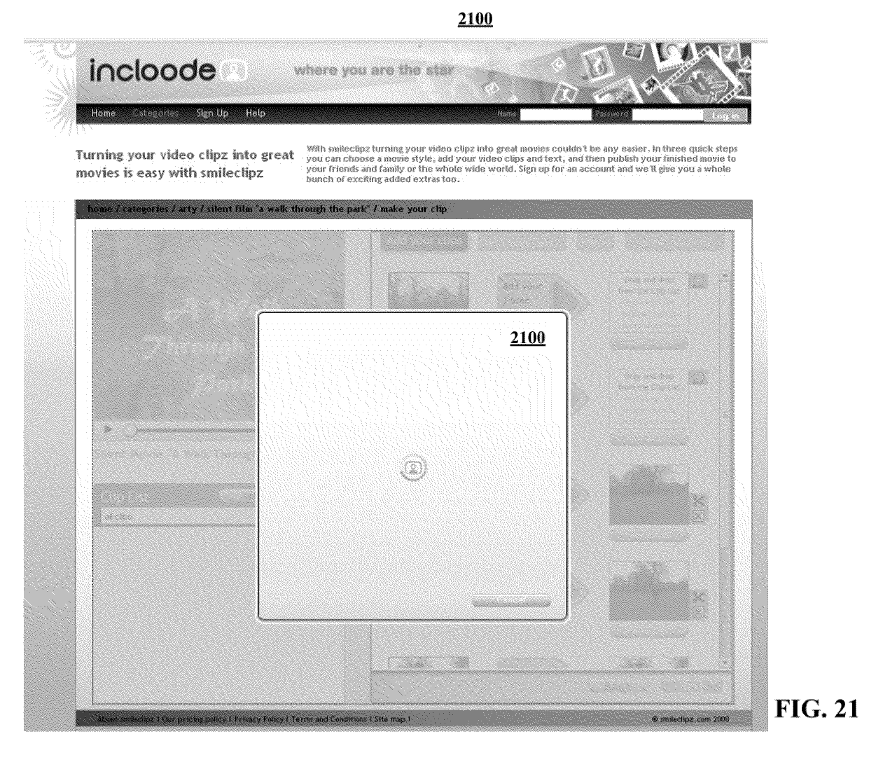

In some embodiments, the application may allow the end user to edit the end user-generated media content by deleting the media content. For example, as shown in FIG. 20, in response to removing the end user-generated media content, the application allows the end user to insert another piece of end user-generated media content (e.g., browse through the end user device, drag and drop, etc.). In some embodiments, the application may allow the user to record the end user-generated media content using a webcam or any other suitable video capturing device. For example, in response to selecting webcam button 2004, the application may display webcam interface 2100 as shown in FIG. 21.

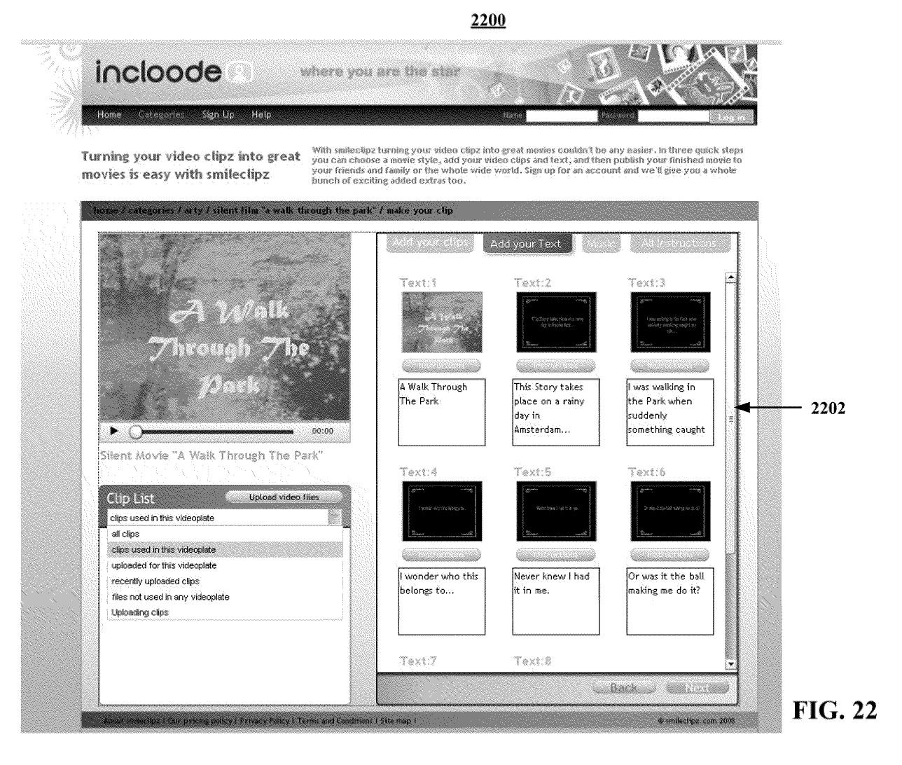

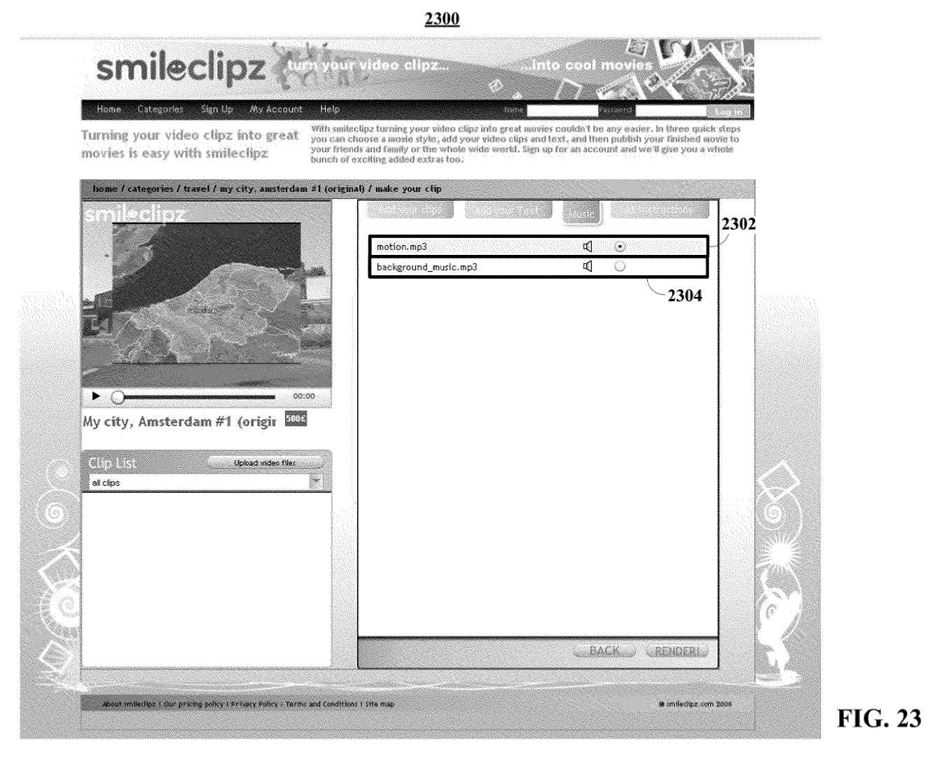

In some embodiments, the application may allow the end user to provide further customizations to the video clip. For example, as shown in FIG. 22, the application may allow the end user to insert text into the video clip in area 2202. As shown in FIG. 22, the application may request that the user input text into particular portions of the video clip. In another example, as shown in FIG. 23, the application may allow the end user to select from multiple audio clips 2302 and 2304 for playback in the video clip. In some embodiments, the application may allow the end user to insert an audio clip stored on the end user device. Alternatively, the application may retrieve one or more audio clips from a database (e.g., the database that stores the video templates).

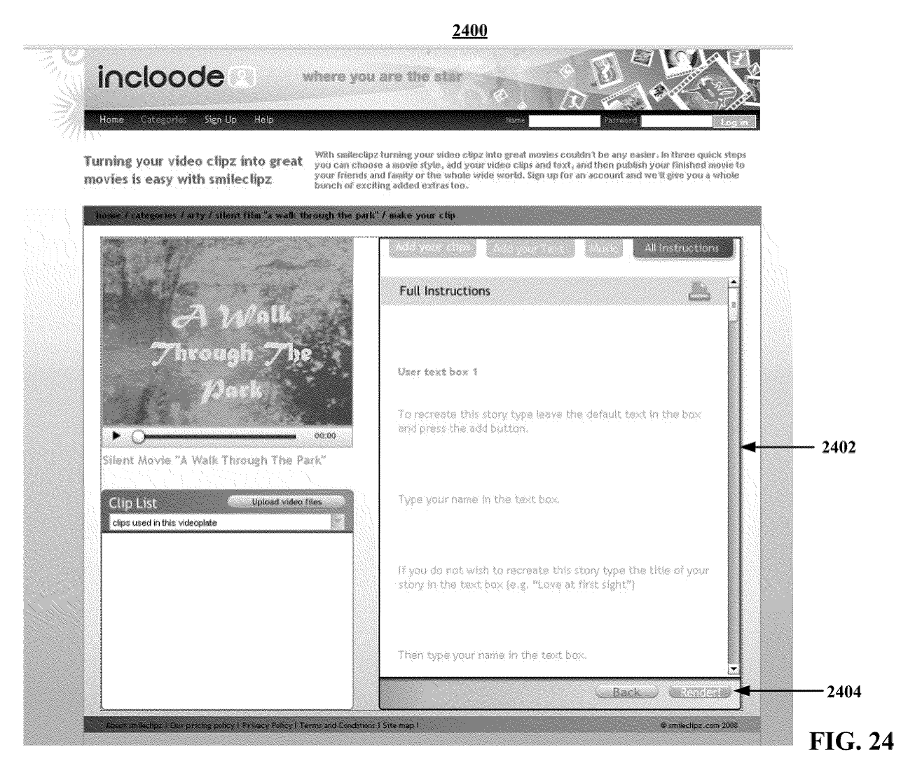

In some embodiments, the application may provide the end user with an entire script or storyboard. For example, as shown in script area 2402 of FIG. 24, the application provides the end user with all instructions needed to create the video clip using the selected video template. The end user may review the script before determining whether to record and insert the various media content needed to create the video clip. In another example, peers, other video producers, other video template creators, and/or any other suitable users may use script area 2402 to review the script of the selected video template and rate the user that created the video template.

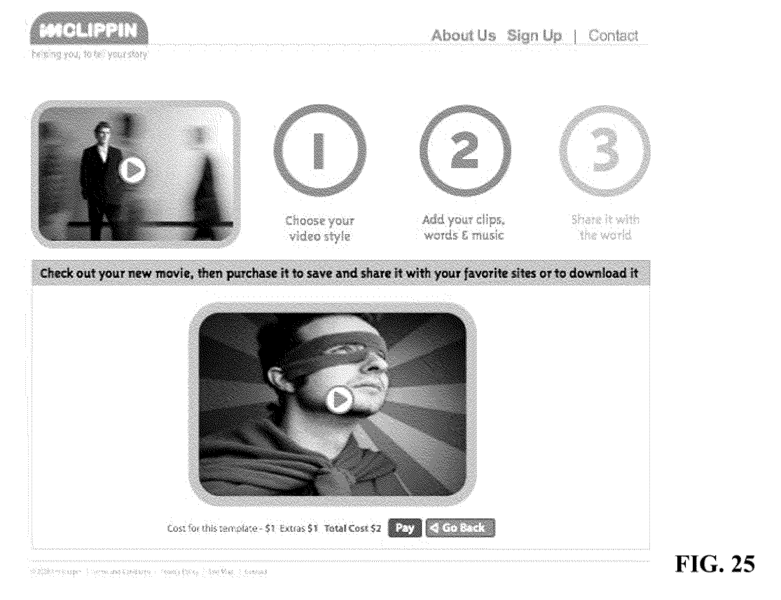

Referring back to FIG. 7, based on the selected video template, the end user-generated media content, and the received parameters and/or setting, a customized video clip is rendered or created for the end user at 760. For example, in response to selecting render button 2404 of FIG. 24, the application may render, mix, and/or produce the customized video clip. As shown in FIGS. 25-28, the application may mix and create the customized video clip in response to receiving a payment from the end user. In response to receiving a payment from the end user (e.g., a short message service (SMS) payment, a credit card payment, a micropayment, etc.), the application may transmit a download link to the end user that allows the end user to download a full quality video (e.g. 640×480 resolution at 25 frames per second and in Flash Video (.FLV) format). In addition, the application may place a portion of the received payment into an account associated with the user that created the video template.

In some embodiments, the application may provide end user with collaboration features. For example, in some embodiments, the application may allow the end user to send communications to other end users (e.g., friends, colleagues, etc.) requesting that the other end users upload additional end user-generated media content (e.g., webcam content, content recorded using a cellular phone, content recorded using a video camera, etc.). The communication may include, for example, a link to a webpage that allows other end users to directly upload end user-generated media content into the video template selected by the end user. In response, the application may provide the end user with one or more notifications that new end user-generated media content has been uploaded. The new end user-generated media content may be placed, for example, in an area displaying media assets available to the end user.

Alternatively, the application may allow the end user to associate a user list (e.g., a list of friends) with a selected video template. Those end users added to the user list may upload end user-generated media content, where the uploaded content is placed along with other media assets available to the end user that created the user list. In response, the end user may create a customized video clip using the end user-generated media content uploaded by the end users on the user list.

For example, when creating a congratulatory wedding video clip, the end user may request that other attendants at the wedding ceremony upload video clips, images, and/or other suitable media content. The request or communication may include a link to a website that allows the attendants to upload media content recorded by the particular attendant. In response to receiving new media content, the end user that is creating the congratulatory wedding video clip using a suitable video template is send a notification that new media content is available for insertion into the selected video template.

In some embodiments, these customized video clips may be uploaded onto particular web pages (e.g., social networking web pages, blogs or any other suitable web logs, vlogs or any other suitable video logging webpage, etc.), sent to one or more cellular telephones having video playback capabilities (e.g., video SMS, MMS, etc.), etc. In this way, end users have produced professional video clips easier, faster, and cheaper while making use of end user-generated content that has been captured but not shared with peers.

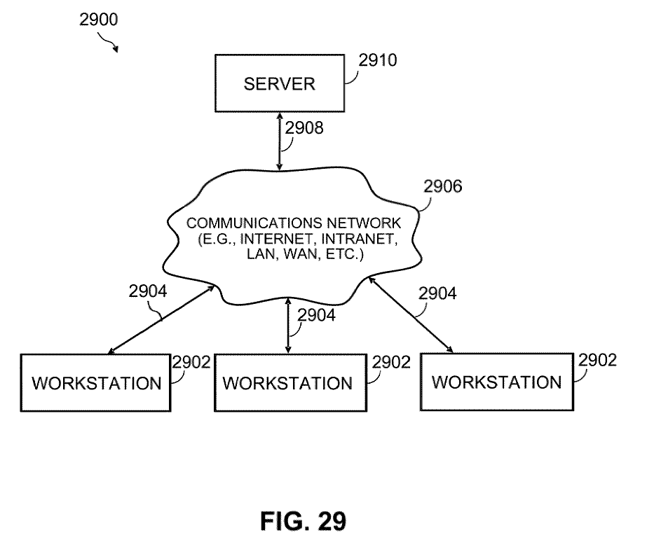

FIG. 29 is a schematic diagram of an illustrative system 2900 suitable for implementation of an application that creates, produces, and distributes video templates and video clips in accordance with some embodiments. As illustrated, system 2900 may include one or more workstations 2902. Workstations 2902 may be local to each other or remote from each other, and are connected by one or more communications links 2904 to a communications network 2906 that is linked via a communications link 2908 to a server 2910.

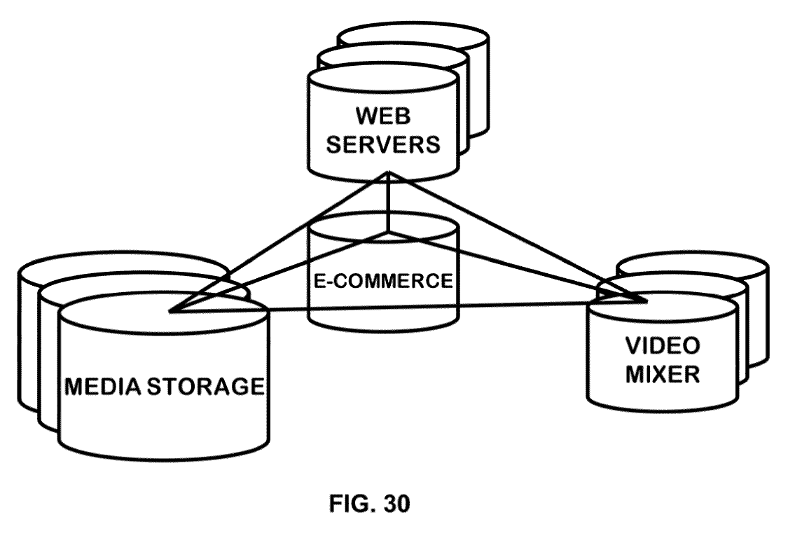

In system 2900, server 2910 may be any suitable server for executing the application, such as a processor, a computer, a data processing device, or a combination of such devices. For example, as shown in FIG. 30, system 2900 may include multiple servers that are capable of communicating with each other—e.g., a web server (e.g., an Apache web server), a server for video mixing, a server for media storage and streaming (e.g., an Adobe Flash media server), a customer relationship management (CRM) or electronic commerce server (e.g., a server running an electronic commerce solution, such as X-Cart), a customer support server (e.g., a server running Cerberus Helpdesk or any other suitable customer support application), and a payment server.

In some embodiments, server 2910 may be coupled to a database or a database may be incorporated into server 2910. It should be noted that the database may be any suitable mechanism for retrieving and/or storing video templates, media assets, information associated with users, information associated with end users, payment information, user device information, end user device information, and/or any other suitable information. For example, the database may be a flat file database, a relational database (e.g., a structured query language (SQL) database), a hierarchical database, a database structure used for rapid delivery of data, a database structure that has been tuned for read-only delivery for data, a client-based cache, or any other suitable storage device.

Communications network 2906 may be any suitable computer network including, for example, the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 2904 and 2908 may be any communications links suitable for communicating data between workstations 2902 and server 2910, such as network links, dial-up links, wireless links, hard-wired links, etc. Workstations 2902 may be personal computers, laptop computers, mainframe computers, dumb terminals, data displays, Internet browsers, personal digital assistants (PDAs), two-way pagers, wireless terminals, portable telephones, photographic devices, media capturing devices, etc., or any combination of the same. Workstations 2902 and server 2910 may be located at any suitable locations (e.g., a video template designer workstation at one location and an end user workstation at another location). In one embodiment, workstations 2902 and server 10 may be located within an organization. Alternatively, workstations 1802 and server 1810 may be distributed between multiple organizations.

In most embodiments, the methods of the present application will be implemented on machines that are programmed according to the techniques described with respect to the embodiments for carrying out the functional features of the methods. Such machines include, but are not limited to, general purpose computers, special purpose computers, etc.

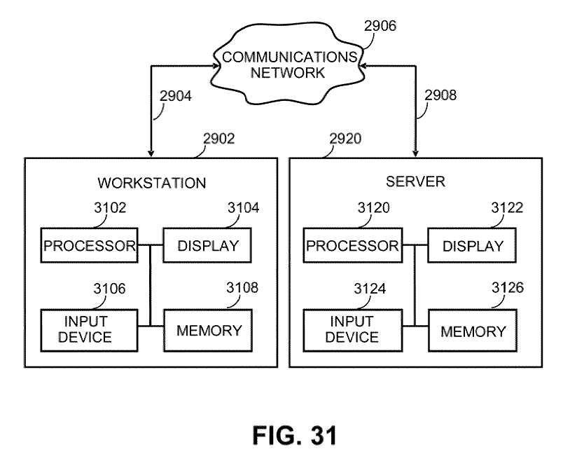

The server and one of the workstations, which are depicted in FIG. 29, are illustrated in more detail in FIG. 31. Referring to FIG. 31, workstation 2902 may include processor 3102, display 3104, input device 3106, and memory 3108, which may be interconnected. In a preferred embodiment, memory 3108 contains a storage device for storing a workstation program for controlling processor 3102. Memory 3108 may also contain an application for creating, producing, and/or distributing video templates and video clips in accordance with some embodiments. In some embodiments, the application may be resident in the memory of workstation 2902 or server 2910.

In some embodiments, the application may include an application program interface (not shown), or alternatively, the application may be resident in the memory of workstation 2902 or server 2910. In another suitable embodiment, the only distribution to workstation 2902 may be a graphical user interface (“GUI”) which allows a user to interact with the application resident at, for example, server 2910.

In one particular embodiment, the application may include client-side software, hardware, or both. For example, the application may encompass one or more Web-pages or Web-page portions (e.g., via any suitable encoding, such as HyperText Markup Language (HTML), Dynamic HyperText Markup Language (DHTML), Extensible Markup Language (XML), JavaServer Pages (JSP), Active Server Pages (ASP), Cold Fusion, or any other suitable approaches).

In another particular embodiment, the application may be designed as a standalone application that is installed locally on each computer or device to allows users to create, produce, and/or distribution video templates and/or video clips. For example, a catalogue of video templates and the media application may be locally installed on a device such that a communications network (e.g., communications network 2906 of FIG. 29) is not needed. In another example, the media application may be locally installed on video cameras and other video capturing devices, portable photographic devices, standalone media kiosks, etc.

Although the application is described herein as being implemented on a workstation, this is only illustrative. The application may be implemented on any suitable platform (e.g., a personal computer (PC), a mainframe computer, a dumb terminal, a data display, a two-way pager, a wireless terminal, a portable telephone, a portable computer, a palmtop computer, a handheld personal computer (H/PC), an automobile PC, a laptop computer, a personal digital assistant (PDA), a combined cellular phone and PDA, a digital camera, a video camera, etc.) to provide such features.

Processor 3102 may use the workstation program to present on display 3104 the application and the data received through communication link 2904 and commands and values transmitted by a user of workstation 2902. It should also be noted that data received through communication link 2904 or any other communications links may be received from any suitable source, such as web services. Input device 3106 may be a computer keyboard, a mouse, a touch-sensitive screen, a cursor-controller, a dial, a switchbank, lever, or any other suitable input device as would be used by a designer of input systems or process control systems.

Server 2910 may include processor 3120, display 3122, input device 3124, and memory 3126, which may be interconnected. In a preferred embodiment, memory 3126 contains a storage device for storing data received through communication link 2908 or through other links, and also receives commands and values transmitted by one or more users. The storage device further contains a server program for controlling processor 3120.

The system according to the invention may include a general purpose computer, or a specially programmed special purpose computer. The user may interact with the system via e.g., a personal computer or over PDA, e.g., the Internet, an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components may be employed in such embodiments of the present invention. For example, at least some of the functionality mentioned above could be implemented using Visual Basic, C, C++ or any assembly language appropriate in view of the processor being used. It could also be written in an object oriented and/or interpretive environment such as Java and transported to multiple destinations to various users.

Accordingly, methods, systems, and media for creating, producing, and distributing video templates and video clips are provided.

Although the invention has been described and illustrated in the foregoing illustrative embodiments, it is understood that the present disclosure has been made only by way of example, and that numerous changes in the details of implementation of the invention may be made without departing from the spirit and scope of the invention, which is only limited by the claims that follow. Features of the disclosed embodiments may be combined and rearranged in various ways.

What is claimed is:

1. A method for assisting end users create customized video clips, the method comprising:
displaying a timeline interface in a window area that includes a plurality of layers, wherein the timeline interface allows a user at a first device to create a video template;
displaying an asset interface in the window area that allows the user at the first device to select from a plurality of media assets for insertion into the video template;
receiving, for each of the plurality of layers, selections from the user at the first device to insert and arrange at least one of the plurality of media assets from the asset interface into a plurality of media blocks in the timeline interface for a video template;
receiving at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block;
receiving, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of: a video length, a playback speed, a video setting, a volume setting, a screen position, a mask setting, and a video effect; and
storing the video template and information associated with the user at the first device in a database that includes a plurality of video templates for distribution to the end users.

2. The method of claim 1, further comprising receiving a request from the user to publish the video template.

3. The method of claim 1, further comprising publishing the video template in a catalog that includes a plurality of video templates.

4. The method of claim 1, further comprising further comprising distributing the plurality of video templates stored in the database to a content distributor.

5. The method of claim 1, further comprising transmitting a notification to a content distributor in response to storing the video template in the database.

6. The method of claim 1, further comprising:
determining whether the end user media block is the first end user media block inserted into the video template; and
in response to determining that the end user media block is the first end user media block inserted into the video template, designating the end user media block as a parent end user media block.

7. The method of claim 1, further comprising:
determining whether the end user media block is the first end user media block inserted into the video template; and
in response to determining that the end user media block is not the first end user media block inserted into the video template, designating the end user media block as a child end user media block.

8. The method of claim 1, further comprising:
receiving a selection from an end user to create a customized video clip using the video template;
displaying the selected video template, wherein the selected video template includes the end user media block; and
displaying the instructions associated with the end user media block that provide directions for generating video content suitable for insertion into the end user media block.

9. The method of claim 8, further comprising receiving end user-generated media content for insertion into the end user media block.

10. The method of claim 9, further comprising analyzing the end user-generated media content for compliance with the displayed instructions.

11. The method of claim 1, further comprising:
receiving a payment for using the video template to create a customized video clip; and
transmitting at least a portion of the payment into an account associated with the user that created the video template.

12. The method of claim 1, further comprising:
receiving a payment for using the video template to create a customized video clip; and
transmitting a credit into an account associated with the user that created the video template.

13. A system for assisting end users create customized video clips, the system comprising:
means for displaying an asset interface in the window area that allows the user at the first device to select from a plurality of media assets for insertion into the video template;
means for receiving, for each of the plurality of layers, selections from the user at the first device to insert and arrange at least one of the plurality of media assets from the asset interface into a plurality of media blocks in the timeline interface for a video template;
means for receiving at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block;
means for receiving, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of: a video length, a playback speed, a video setting, a volume setting, a screen position, a mask setting, and a video effect; and
means for storing the video template and information associated with the user at the first device in a database that includes a plurality of video templates for distribution to the end users.

14. The system of claim 13, further comprising means for receiving a request from the user to publish the video template.

15. The system of claim 13, further comprising means for publishing the video template in a catalog that includes a plurality of video templates.

16. The system of claim 13, further comprising means for further comprising distributing the plurality of video templates stored in the database to a content distributor.

17. The system of claim 13, further comprising means for transmitting a notification to a content distributor in response to storing the video template in the database.

18. The system of claim 13, further comprising:
means for determining whether the end user media block is the first end user media block inserted into the video template; and
means for designating the end user media block as a parent end user media block in response to determining that the end user media block is the first end user media block inserted into the video template.

19. The system of claim 13, further comprising:
means for determining whether the end user media block is the first end user media block inserted into the video template; and
means for designating the end user media block as a child end user media block in response to determining that the end user media block is not the first end user media block inserted into the video template.

20. The system of claim 13, further comprising:
means for receiving a selection from an end user to create a customized video clip using the video template;
means for displaying the selected video template, wherein the selected video template includes the end user media block; and
means for displaying the instructions associated with the end user media block that provide directions for generating video content suitable for insertion into the end user media block.

21. The system of claim 20, further comprising means for receiving end user-generated media content for insertion into the end user media block.

22. The system of claim 21, further comprising means for analyzing the end user-generated media content for compliance with the displayed instructions.

23. The system of claim 13, further comprising:
means for receiving a payment for using the video template to create a customized video clip; and
means for transmitting at least a portion of the payment into an account associated with the user that created the video template.

24. The system of claim 13, further comprising:
means for receiving a payment for using the video template to create a customized video clip; and
means for transmitting a credit into an account associated with the user that created the video template.

25. A system for assisting end users create customized video clips, the system comprising:
a processor that:
displays an asset interface in the window area that allows the user at the first device to select from a plurality of media assets for insertion into the video template;
receives, for each of the plurality of layers, selections from the user at the first device to insert and arrange at least one of the plurality of media assets from the asset interface into a plurality of media blocks in the timeline interface for a video template;
receives at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block;
receives, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of: a video length, a playback speed, a video setting, a volume setting, a screen position, a mask setting, and a video effect; and
stores the video template and information associated with the user at the first device in a database that includes a plurality of video templates for distribution to the end users.

26. The system of claim 25, wherein the processor is further configured to receive a request from the user to publish the video template.

27. The system of claim 25, wherein the processor is further configured to publish the video template in a catalog that includes a plurality of video templates.

28. The system of claim 25, wherein the processor is further configured to distribute the plurality of video templates stored in the database to a content distributor.

29. The system of claim 25, wherein the processor is further configured to transmit a notification to a content distributor in response to storing the video template in the database.

30. The system of claim 25, wherein the processor is further configured to:
determine whether the end user media block is the first end user media block inserted into the video template; and
in response to determining that the end user media block is the first end user media block inserted into the video template, designate the end user media block as a parent end user media block.

31. The system of claim 25, wherein the processor is further configured to:
determine whether the end user media block is the first end user media block inserted into the video template; and
in response to determining that the end user media block is not the first end user media block inserted into the video template, designate the end user media block as a child end user media block.

32. The system of claim 25, wherein the processor is further configured to:
receiving a selection from an end user to create a customized video clip using the video template;
displaying the selected video template, wherein the selected video template includes the end user media block; and
displaying the instructions associated with the end user media block that provide directions for generating video content suitable for insertion into the end user media block.

33. The system of claim 32, wherein the processor is further configured to receive end user-generated media content for insertion into the end user media block.

34. The system of claim 33, wherein the processor is further configured to analyze the end user-generated media content for compliance with the displayed instructions.

35. The system of claim 25, wherein the processor is further configured to:
receive a payment for using the video template to create a customized video clip; and
transmit at least a portion of the payment into an account associated with the user that created the video template.

36. The system of claim 25, wherein the processor is further configured to:
receive a payment for using the video template to create a customized video clip; and
transmit a credit into an account associated with the user that created the video template.

37. A computer-readable medium storing computer-executable instructions that, when executed by a processor, causes the processor to perform a method for assisting end users create customized video clips, the method comprising:
displaying a timeline interface in a window area that includes a plurality of layers, wherein the timeline interface allows a user at a first device to create a video template;
displaying an asset interface in the window area that allows the user at the first device to select from a plurality of media assets for insertion into the video template;
receiving, for each of the plurality of layers, selections from the user at the first device to insert and arrange at least one of the plurality of media assets from the asset interface into a plurality of media blocks in the timeline interface for a video template;
receiving at least one request from the user at the first device to replace at least one of the plurality of media blocks with an end user media block, wherein the end user media block is designated for end user-generated video content inserted by an end user at a second device and wherein the media asset associated with the replaced media block is displayed to the end user at the second device as an example of end user-generated video content suitable for insertion into the end user media block;
receiving, from the user at the first device, parameters associated with the plurality of media blocks and instructions associated with the end user media block, wherein the instructions provide the end user at the second device with directions for generating video content suitable for insertion into the end user media block and are displayed with the video template, and wherein the parameters modify each of the plurality of media blocks and include at least one of: a video length, a playback speed, a video setting, a volume setting, a screen position, a mask setting, and a video effect; and
storing the video template and information associated with the user at the first device in a database that includes a plurality of video templates for distribution to the end users.

38. The computer-readable medium of claim 37, wherein the method further comprises receiving a request from the user to publish the video template.

39. The computer-readable medium of claim 37, wherein the method further comprises publishing the video template in a catalog that includes a plurality of video templates.

40. The computer-readable medium of claim 37, wherein the method further comprises distributing the plurality of video templates stored in the database to a content distributor.

41. The computer-readable medium of claim 37, wherein the method further comprises transmitting a notification to a content distributor in response to storing the video template in the database.

42. The computer-readable medium of claim 37, wherein the method further comprises:
determining whether the end user media block is the first end user media block inserted into the video template; and
in response to determining that the end user media block is the first end user media block inserted into the video template, designating the end user media block as a parent end user media block.

43. The computer-readable medium of claim 37, wherein the method further comprises:
determining whether the end user media block is the first end user media block inserted into the video template; and
in response to determining that the end user media block is not the first end user media block inserted into the video template, designating the end user media block as a child end user media block.

44. The computer-readable medium of claim 37, wherein the method further comprises:
receiving a selection from an end user to create a customized video clip using the video template;
displaying the selected video template, wherein the selected video template includes the end user media block; and
displaying the instructions associated with the end user media block that provide directions for generating video content suitable for insertion into the end user media block.

45. The computer-readable medium of claim 44, wherein the method further comprises receiving end user-generated media content for insertion into the end user media block.

46. The computer-readable medium of claim 45, wherein the method further comprises analyzing the end user-generated media content for compliance with the displayed instructions.

47. The computer-readable medium of claim 37, wherein the method further comprises:
receiving a payment for using the video template to create a customized video clip; and
transmitting at least a portion of the payment into an account associated with the user that created the video template.

48. The computer-readable medium of claim 37, wherein the method further comprises:
receiving a payment for using the video template to create a customized video clip; and
transmitting a credit into an account associated with the user that created the video template.
